(19) United States
(12) Patent Application Publication
(10) Pub. No.: US 2026/0070825 A1
(43) Pub. Date: Mar. 12, 2026

(54) Systems and Methods for Water Treatment Using Ion Exchange and Water Softening Techniques

(71) Applicant: Carollo Engineers, Inc., Costa Mesa, CA (US)

(72) Inventors: Vincent Hart, Tampa, FL (US); Melanie Pickett, Tampa, FL (US); Eva Steinle-Darling, Austin, TX (US); Yun Yu, Broomfield, CO (US)

(21) Appl. No.: 18/857,486

(22) PCT Filed: Mar. 28, 2024
(86) PCT No.: PCT/US2024/021981

§ 371 Date: Oct. 17, 2024

Related U.S. Application Data
(60) Provisional application No. 63/493,548, filed on Mar. 31, 2023.
(60) Provisional application No. 63/493,531, filed on Mar. 31, 2023.

(51) Int. Cl. C02F 5/02

(52) U.S. Cl. CPC C02F 5/02; C02F 2209/06; C02F 2303/16; C02F 2305/00

(57) ABSTRACT

An ion exchange system for treating water, includes a semi-plug flow reactor having an inflow of water and ion exchange resin. The ion exchange resin includes a positively charged resin bead and at least one counter anion bonded to the resin bead. The water includes at least one contaminant anion therein. The ion exchange system for treating water includes a resin separator in fluid communication with the semi-plug flow reactor. The resin separator has an inflow of the water and the ion exchange resin from the semi-plug flow reactor. The ion exchange system for treating water includes a resin regeneration vessel in fluid communication with the resin separator. The resin regeneration vessel has an inflow of the ion exchange resin from the resin separator and an inflow of a regenerant solution. The regenerant solution includes at least one regenerant anion therein.

### CROSS REFERENCE TO RELATED APPLICATIONS

This application is the United States national phase of International Patent Application No. PCT/US24/21981 filed Mar. 28, 2024, and claims priority to U.S. Provisional Patent Application No. 63/493,531, entitled “Systems and Methods for Water Treatment Using Ion Exchange and Water Softening Techniques”, filed Mar. 31, 2023 and U.S. Provisional Patent Application No. 63/493,548, entitled “Systems and Methods for Generating Bicarbonate Solution from Sodium Hydroxide and Carbon Dioxide”, filed Mar. 31, 2023, the disclosures of which are hereby incorporated by reference in their entireties.

### BACKGROUND

### Technical Field

The present disclosure relates to treatment of water for reuse. More particularly, it relates to a treatment system and method for water treatment using ion exchange in combination with softening.

### Technical Description

For both direct potable reuse (DPR) and indirect potable reuse (IPR) applications, common treatment approaches are generally limited to two approaches. The first approach is typically based upon reverse osmosis (RO), known as RO-based advanced treatment (RBAT), and the second approach is based upon ozone-biologically active filtration (BAF)-granular activated carbon (GAC) adsorption, namely, carbon-based advanced treatment (CBAT).

While RO produces consistent and exceptional quality product water, this treatment process is energy-intensive and often leads to high capital and operation and maintenance (O&M) costs. Additionally, RO concentrate constitutes 15 to 25 percent of the total feed flow and requires disposal through ocean discharge, deep well injection, high-salinity surface water discharge, or other costly methods. For inland communities without an option for ocean discharge, concentrate disposal can be cost-prohibitive and render otherwise viable potable reuse applications infeasible. RO concentrate is also extremely saline and corrosive, which can be problematic for discharge into a sewer system and causes negative impacts on receiving municipal wastewater treatment facilities.

CBAT leverages a combination of chemical and biological oxidation as well as physical adsorption processes and can produce a similarly acceptable quality product water as RBAT without generating a concentrated liquid waste stream. While CBAT integrates multiple treatment barriers for the control of both pathogenic and chemical contaminants, it is currently limited to potable reuse applications where source water salinity is not a concern. This is because none of the unit treatment processes in a CBAT train achieves measurable removal of inorganic salts.

Thus, both typical approaches to water treatment for potable reuse have substantial challenges related to salinity and several other water quality parameters, including but not limited to bromide, nitrate, and nitrite removal, and accordingly, those skilled in the art continue research and development in the field of water and wastewater treatment.

### SUMMARY

In some non-limiting embodiments or aspects, an ion exchange system for treating water includes a semi-plug flow reactor having an inflow of water and ion exchange resin. The ion exchange resin includes a positively charged resin bead and at least one counter anion bonded to the resin bead, and the water includes at least one contaminant anion therein. The semi-plug flow reactor is configured to allow a continuous, semi-plug flow of the water and the ion exchange resin through and out of the semi-plug flow reactor. The ion exchange resin is suspended in the water and exchanges one or more of the at least one counter anion with one or more of the at least one contaminant anion in the water during the flow through and out of the semi-plug flow reactor. The ion exchange system for treating water includes a resin separator in fluid communication with the semi-plug flow reactor. The resin separator has an inflow of the water and the ion exchange resin from the semi-plug flow reactor. The resin separator is configured to separate at least a portion of the water from the ion exchange resin. The separated portion of the water includes a treated effluent, and the treated effluent includes one or more of the at least one counter anion therein. The ion exchange system for treating water includes a resin regeneration vessel in fluid communication with the resin separator. The resin regeneration vessel has an inflow of the ion exchange resin from the resin separator and an inflow of a regenerant solution. The regenerant solution includes at least one regenerant anion therein. The ion exchange resin exchanges one or more of the at least one contaminant anion with one or more of the at least one regenerant anion in the regenerant solution. The resin regeneration vessel is configured to separate a waste regenerant solution from the ion exchange resin. The waste regenerant solution includes one or more of the at least one contaminant anion therein.

In some non-limiting embodiments or aspects, the ion exchange system for treating water can include a resin return line in fluid communication with the resin regeneration vessel. The resin return line can be configured to return the ion exchange resin to the semi-plug flow reactor. In some non-limiting embodiments or aspects, the ion exchange system for treating water can include a resin holder in fluid communication with the resin regeneration vessel. The resin holder can include an inflow of the ion exchange resin from the resin regeneration vessel and an inflow of rinse water. The resin holder can be configured to suspend the ion exchange resin in the rinse water. In some non-limiting embodiments or aspects, the ion exchange system for treating water can include a resin return line in fluid communication with the resin holder. The resin return line can be configured to return the ion exchange resin to the semi-plug flow reactor.

In some non-limiting embodiments or aspects, the ion exchange system for treating water can include a softening reactor in fluid communication with the resin separator. The softening reactor can include an inflow of the treated effluent from the resin separator, an inflow of calcium hydroxide (Ca(OH)₂), and an inflow of a seeding material. The softening reactor can be configured to generate an upward flow of the treated effluent, the calcium hydroxide, and the seeding material therein. The at least one counter anion in the treated effluent and the calcium hydroxide can react and form a precipitated solid on a surface of the seeding material in the treated effluent. The precipitated solid can settle in the treated effluent to a bottom of the softening reactor.

In some non-limiting embodiments or aspects, the softening reactor can be an upflow fluidized reactor. In some non-limiting embodiments or aspects, the softening reactor can be configured to separate at least a portion of the treated effluent from the precipitated solid and remove the precipitated solid settled therein. The separated portion of the treated effluent can be a treated and softened effluent. In some non-limiting embodiments or aspects, the softening reactor can be in fluid communication with the resin holder, and the inflow of the rinse water includes the treated and softened effluent separated from the softening reactor. In some non-limiting embodiments or aspects, the ion exchange system for treating water can include a hopper in fluid communication with the softening reactor. The hopper can include an inflow of the precipitated solid from the softening reactor. The hopper can be configured to hold, dry, and dispense the precipitated solid.

In some non-limiting embodiments or aspects, each of the at least one counter anion and the at least one regenerant anion can be bicarbonate (HCO₃⁻) and the regenerant solution can be a bicarbonate solution. In some non-limiting embodiments or aspects, the ion exchange system for treating water can include a system for generating the bicarbonate solution, as the regenerant solution. The system for generating the bicarbonate solution can be in fluid communication with the resin regeneration vessel and in-line with the inflow of the regenerant solution. The system for generating bicarbonate solution can include a reaction vessel having an inflow of water (H₂O) and sodium hydroxide (NaOH). The water and the sodium hydroxide can combine to form a solution in the reaction vessel. The system for generating bicarbonate solution can include a gas sparger in fluid communication with the reaction vessel. The gas sparger can provide an inflow of carbon dioxide (CO₂) gas into the solution in the reaction vessel. The sodium hydroxide and the carbon dioxide can react to form at least bicarbonate (HCO₃⁻) in the solution. In some non-limiting embodiments or aspects, the system for generating bicarbonate solution can include a controller in communication with the inflow of the water, the inflow of the sodium hydroxide, and the inflow of the carbon dioxide gas. The controller can be configured to control a flow of the inflow of the water, the inflow of the sodium hydroxide, and the inflow of the carbon dioxide gas.

In some non-limiting embodiments or aspects, the at least one contaminant anion can include at least one of the following: dissolved organic carbon (DOC), nitrate (NO₃⁻), nitrite (NO₂⁻), sulfate (SO₄²⁻), bicarbonate (HCO₃⁻), phosphate (PO₄³⁻), chloride (Cl⁻), bromide (Br⁻), anionic perfluoroalkyl and polyfluoroalkyl substances (PFAS), or any combination thereof. In some non-limiting embodiments or aspects, the flow of the water and the ion exchange resin through the semi-plug flow reactor can have a flow time of approximately 10 to 30 minutes. In some non-limiting embodiments or aspects, the resin separator can be plate settler. In some non-limiting embodiments or aspects, the ion exchange system for treating water can include a calcium hydroxide holding vessel in fluid communication with the softening reactor and in-line with the inflow of the calcium hydroxide. The calcium hydroxide can be in a liquid solution in the holding vessel.

In some non-limiting embodiments or aspects, the ion exchange system for treating water can include at least one advanced treatment system for treating water in fluid communication with the softening reactor, the at least one advanced treatment system can include an inflow of the treated and softened effluent separated from the softening reactor. In some non-limiting embodiments or aspects, the at least one advanced treatment system can include at least one of the following: microfiltration (MF), ultrafiltration (UF), granular media filtration (GMF), ozone (O₃) treatment, biological activated carbon (BAC) treatment, biological active filtration (BAF), granular activated carbon (GAC) treatment, ultraviolet light (UV) treatment, ultraviolet light-advanced oxidation process (UV-AOP) treatment, chlorine contact treatment, or any combination thereof.

In some non-limiting embodiments or aspects, a method for treating water includes flowing water and ion exchange resin through and out of a reactor. The ion exchange resin includes a positively charged resin bead and at least one counter anion bonded to the resin bead. The water includes at least one contaminant anion therein. The flow of the water and the ion exchange resin is a continuous, semi-plug flow. The ion exchange resin is suspended in the water and exchanges one or more of the at least one counter anion with one or more of at least one contaminant anion in the water during the flow through and out of the plug flow reactor. The method for treating water includes separating at least a portion of the water from the ion exchange resin. The separated portion of the water includes a treated effluent, and the treated effluent includes one or more of the at least one counter anion therein. The method for treating water includes regenerating the ion exchange resin by contacting the ion exchange resin with a regenerant solution. The regenerant solution includes at least one regenerant anion therein. The ion exchange resin exchanges one or more of the at least one contaminant anion with one or more of the at least one regenerant anion in the regenerant solution. The method for treating water includes separating a waste regenerant solution from the ion exchange resin. The waste regenerant solution includes the at least one contaminant anion therein.

In some non-limiting embodiments or aspects, the method for treating water can include rinsing the ion exchange resin with a rinse water. In some non-limiting embodiments or aspects, the method for treating water can include suspending the ion exchange resin in the rinse water. In some non-limiting embodiments or aspects, the method for treating water can include returning the ion exchange resin to the reactor.

In some non-limiting embodiments or aspects, the method for treating water can include flowing the treated effluent, calcium hydroxide, and a seeding material upward through a softening reactor. The at least one counter anion in the treated effluent and the calcium hydroxide can react and form a precipitated solid on the surface of the seeding material in the treated effluent. The precipitated solid can settle in the treated effluent to a bottom of the softening reactor.

In some non-limiting embodiments or aspects, the method for treating water can include separating at least a portion of the treated effluent from the precipitated solid. The separated portion of the treated effluent can include a treated and softened effluent. In some non-limiting embodiments or aspects, the method for treating water can include removing the precipitated solid from the softening reactor. In some non-limiting embodiments or aspects, the method for treating water can include using at least a portion of the treated and softened effluent as the rinse water by rinsing the ion exchange with the treated and softened effluent.

In some non-limiting embodiments or aspects, each of the at least one counter anion and the at least one regenerant anion can be bicarbonate (HCO₃⁻) and the regenerant solution can be a bicarbonate solution. In some non-limiting embodiments or aspects, the method for treating water can include a method for generating bicarbonate solution, as the regenerant solution. The method for generating bicarbonate solution can include flowing water (H₂O) into a vessel. The method for generating bicarbonate solution can include introducing sodium hydroxide (NaOH) into the vessel. The water and the sodium hydroxide can combine to form a solution. The method for generating bicarbonate solution can include sparging a carbon dioxide (CO₂) gas in the solution. The sodium hydroxide and the carbon dioxide can react to form at least bicarbonate (HCO₃⁻) in the solution. The method for generating bicarbonate solution can include controlling a flow of the water, the sodium hydroxide, and the carbon dioxide gas with a controller.

In some non-limiting embodiments or aspects, the method for treating water can include flowing the water and the ion exchange resin through the reactor for approximately 10 to 30 minutes. In some non-limiting embodiments or aspects, the method for treating water can include flowing the treated and softened effluent from the softening reactor through at least one advanced treatment system. The at least one advanced treatment system can include at least one of the following: microfiltration (MF), ultrafiltration (UF), granular media filtration (GMF), ozone (O₃) treatment, biological activated carbon (BAC) treatment, biological active filtration (BAF), granular activated carbon (GAC) treatment, ultraviolet light (UV) treatment, ultraviolet light-advanced oxidation process (UV-AOP) treatment, chlorine contact treatment, or any combination thereof.

Further non-limiting embodiments or aspects of the present disclosure are set forth in the following numbered clauses.

Clause 1: An ion exchange system for treating water, the system comprising: a semi-plug flow reactor comprising an inflow of water and ion exchange resin, the ion exchange resin comprising a positively charged resin bead and at least one counter anion bonded to the resin bead, and the water comprising at least one contaminant anion therein, wherein the semi-plug flow reactor is configured to allow a continuous, semi-plug flow of the water and the ion exchange resin through and out of the semi-plug flow reactor, and wherein the ion exchange resin is suspended in the water and exchanges one or more of the at least one counter anion with one or more of the at least one contaminant anion in the water during the flow through and out of the semi-plug flow reactor; a resin separator in fluid communication with the semi-plug flow reactor, the resin separator comprising an inflow of the water and the ion exchange resin from the semi-plug flow reactor, wherein the resin separator is configured to separate at least a portion of the water from the ion exchange resin, the separated portion of the water comprising a treated effluent, and the treated effluent comprising one or more of the at least one counter anion therein; a resin regeneration vessel in fluid communication with the resin separator, the resin regeneration vessel comprising an inflow of the ion exchange resin from the resin separator and an inflow of a regenerant solution, the regenerant solution comprising at least one regenerant anion therein, wherein the ion exchange resin exchanges one or more of the at least one contaminant anion with one or more of the at least one regenerant anion in the regenerant solution, and wherein the resin regeneration vessel is configured to separate a waste regenerant solution from the ion exchange resin, the waste regenerant solution comprising one or more of the at least one contaminant anion therein.

Clause 2: The ion exchange system for treating water of Clause 1, further comprising: a resin return line in fluid communication with the resin regeneration vessel, wherein the resin return line is configured to return the ion exchange resin to the semi-plug flow reactor.

Clause 3: The ion exchange system for treating water of Clause 1 or Clause 2, further comprising: a resin holder in fluid communication with the resin regeneration vessel, the resin holder comprising an inflow of the ion exchange resin from the resin regeneration vessel and an inflow of rinse water, wherein the resin holder is configured to suspend the ion exchange resin in the rinse water.

Clause 4: The ion exchange system for treating water of any of Clauses 1-3, further comprising: a resin return line in fluid communication with the resin holder, wherein the resin return line is configured to return the ion exchange resin to the semi-plug flow reactor.

Clause 5: The ion exchange system for treating water of any of Clauses 1-4, further comprising: a softening reactor in fluid communication with the resin separator, the softening reactor comprising an inflow of the treated effluent from the resin separator, an inflow of calcium hydroxide (Ca(OH)₂), and an inflow of a seeding material, wherein the softening reactor is configured to generate an upward flow of the treated effluent, the calcium hydroxide, and the seeding material therein, wherein the at least one counter anion in the treated effluent and the calcium hydroxide react and form a precipitated solid on a surface of the seeding material in the treated effluent, and wherein the precipitated solid settles in the treated effluent to a bottom of the softening reactor.

Clause 6: The ion exchange system for treating water of any of Clauses 1-5, wherein the softening reactor is an upflow fluidized reactor.

Clause 7: The ion exchange system for treating water of any of Clauses 1-6, wherein the softening reactor is configured to: separate at least a portion of the treated effluent from the precipitated solid, the separated portion of the treated effluent comprising a treated and softened effluent, and remove the precipitated solid settled therein.

Clause 8: The ion exchange system for treating water of any of Clauses 1-7, wherein the softening reactor is in fluid communication with the resin holder, and wherein the inflow of the rinse water comprises the treated and softened effluent separated from the softening reactor.

Clause 9: The ion exchange system for treating water of any of Clauses 1-8, further comprising: a hopper in fluid communication with the softening reactor, the hopper comprising an inflow of the precipitated solid from the softening reactor, wherein the hopper is configured to hold, dry, and dispense the precipitated solid.

Clause 10: The ion exchange system for treating water of any of Clauses 1-9, wherein each of the at least one counter anion and the at least one regenerant anion comprises bicarbonate (HCO₃⁻) and the regenerant solution comprises a bicarbonate solution.

Clause 11: The ion exchange system for treating water of any of Clauses 1-10, further comprising: a system for generating the bicarbonate solution, as the regenerant solution, in fluid communication with the resin regeneration vessel and in-line with the inflow of the regenerant solution, the system for generating bicarbonate solution comprising: a reaction vessel comprising an inflow of water (H₂O) and sodium hydroxide (NaOH), wherein the water and the sodium hydroxide combine to form a solution in the reaction vessel; a gas sparger in fluid communication with the reaction vessel, the gas sparger comprising an inflow of gas comprising carbon dioxide (CO₂) into the solution in the reaction vessel; and wherein the sodium hydroxide and the carbon dioxide react to form at least bicarbonate (HCO₃⁻) in the solution.

Clause 12: The ion exchange system for treating water of any of Clauses 1-11, wherein the system for generating bicarbonate solution further comprises: a controller in communication with the inflow of the water, the inflow of the sodium hydroxide, and the inflow of the gas comprising carbon dioxide, wherein the controller is configured to control a flow of the inflow of the water, the inflow of the sodium hydroxide, and the inflow of the gas comprising carbon dioxide.

Clause 13: The ion exchange system for treating water of any of Clauses 1-12, wherein the at least one contaminant anion comprises at least one of the following: dissolved organic carbon (DOC), nitrate (NO₃⁻), nitrite (NO₂⁻), sulfate (SO₄²⁻), bicarbonate (HCO₃⁻), phosphate (PO₄³⁻), chloride (Cl⁻), bromide (Br⁻), anionic perfluoroalkyl and polyfluoroalkyl substances (PFAS), or any combination thereof.

Clause 14: The ion exchange system for treating water of any of Clauses 1-13, wherein the flow of the water and the ion exchange resin through the semi-plug flow reactor comprises a flow time of approximately 10 to 30 minutes.

Clause 15: The ion exchange system for treating water of any of Clauses 1-14, wherein the resin separator is a plate settler.

Clause 16: The ion exchange system for treating water of any of Clauses 1-15, further comprising: a calcium hydroxide holding vessel in fluid communication with the softening reactor and in-line with the inflow of the calcium hydroxide, wherein the calcium hydroxide is in a liquid solution in the holding vessel.

Clause 17: The ion exchange system for treating water of any of Clauses 1-16, further comprising: at least one advanced treatment system for treating water in fluid communication with the softening reactor, the at least one advanced treatment system comprising an inflow of the treated and softened effluent separated from the softening reactor.

Clause 18: The ion exchange system for treating water of any of Clauses 1-17, wherein the at least one advanced treatment system comprises at least one of the following: microfiltration (MF), ultrafiltration (UF), granular media filtration (GMF), ozone (O₃) treatment, biological activated carbon (BAC) treatment, biological active filtration (BAF), granular activated carbon (GAC) treatment, ultraviolet light (UV) treatment, ultraviolet light-advanced oxidation process (UV-AOP) treatment, chlorine contact treatment, or any combination thereof.

Clause 19: A method for treating water, comprising: flowing water and ion exchange resin through and out of a reactor, the ion exchange resin comprising a positively charged resin bead and at least one counter anion bonded to the resin bead, and the water comprising at least one contaminant anion therein, wherein the flow of the water and the ion exchange resin is a continuous, semi-plug flow, and wherein the ion exchange resin is suspended in the water and exchanges one or more of the at least one counter anion with one or more of at least one contaminant anion in the water during the flow through and out of the plug flow reactor; separating at least a portion of the water from the ion exchange resin, the separated portion of the water comprising a treated effluent, and the treated effluent comprising one or more of the at least one counter anion therein; regenerating the ion exchange resin by contacting the ion exchange resin with a regenerant solution, the regenerant solution comprising at least one regenerant anion therein, wherein the ion exchange resin exchanges one or more of the at least one contaminant anion with one or more of the at least one regenerant anion in the regenerant solution; separating a waste regenerant solution from the ion exchange resin, the waste regenerant solution comprising the at least one contaminant anion therein.

Clause 20: The method for treating water of Clause 19, further comprising: rinsing the ion exchange resin with a rinse water; suspending the ion exchange resin in the rinse water; and returning the ion exchange resin to the reactor.

Clause 21: The method for treating water of Clause 19 or Clause 20, further comprising: flowing the treated effluent, calcium hydroxide, and a seeding material upward through a softening reactor, wherein the at least one counter anion in the treated effluent and the calcium hydroxide react and form a precipitated solid on the surface of the seeding material in the treated effluent, and wherein the precipitated solid settles in the treated effluent to a bottom of the softening reactor.

Clause 22: The method for treating water of any of Clauses 19-21, further comprising: separating at least a portion of the treated effluent from the precipitated solid, the separated portion of the treated effluent comprising a treated and softened effluent, and removing the precipitated solid from the softening reactor.

Clause 23: The method for treating water of any of Clauses 19-22, further comprising: using at least a portion of the treated and softened effluent as the rinse water by rinsing the ion exchange with the treated and softened effluent.

Clause 24: The method for treating water of any of Clauses 19-23, wherein each of the at least one counter anion and the at least one regenerant anion comprises bicarbonate (HCO₃⁻) and the regenerant solution comprises a bicarbonate solution.

Clause 25: The method for treating water of any of Clauses 19-24, further comprising: a method for generating bicarbonate solution, as the regenerant solution, the method for generating bicarbonate solution comprising: flowing water (H₂O) into a vessel; introducing sodium hydroxide (NaOH) into the vessel, wherein the water and the sodium hydroxide combine to form a solution; and sparging a gas comprising carbon dioxide (CO₂) in the solution, wherein the sodium hydroxide and the carbon dioxide react to form at least bicarbonate (HCO₃⁻) in the solution.

Clause 26: The method for treating water of any of Clauses 19-25, wherein the method for generating bicarbonate solution further comprises: controlling a flow of the water, the sodium hydroxide, and the gas comprising carbon dioxide with a controller.

Clause 27: The method for treating water of any of Clauses 19-26, further comprising: flowing the water and the ion exchange resin through the reactor for approximately 10 to 30 minutes.

Clause 28: The method for treating water of any of Clauses 19-27, further comprising: flowing the treated and softened effluent from the softening reactor through at least one advanced treatment system.

Clause 29: The method for treating water of any of Clauses 19-28, wherein the at least one advanced treatment system comprises at least one of the following: microfiltration (MF), ultrafiltration (UF), granular media filtration (GMF), ozone (O₃) treatment, biological activated carbon (BAC) treatment, biological active filtration (BAF), granular activated carbon (GAC) treatment, ultraviolet light (UV) treatment, ultraviolet light-advanced oxidation process (UV-AOP) treatment, chlorine contact treatment, or any combination thereof.

### BRIEF DESCRIPTION OF THE DRAWINGS

FIG. 1 is a view of a suspended ion exchange system for treating water, according to some non-limiting embodiments or aspects of the present disclosure;

FIG. 2 is a view of another suspended ion exchange system for treating water, according to some non-limiting embodiments or aspects of the present disclosure;

FIG. 3 is a molecular-scale view of an ion exchange resin undergoing ion exchange using chloride as the regenerant, according to some non-limiting embodiments or aspects of the present disclosure;

FIG. 4 is a molecular-scale view of an ion exchange resin undergoing ion exchange using bicarbonate as the regenerant, according to some non-limiting embodiments or aspects of the present disclosure;

FIG. 5 is a conceptual view showing the interconnection of the following processes: ion exchange with strong base anion (SBA) resin, bicarbonate regeneration, and softening, according to some non-limiting embodiments or aspects of the present disclosure. FIG. 5 includes a diagram of the relationship between the chemical reactions used in ion exchange, bicarbonate regeneration, and softening processes, according to some non-limiting embodiments or aspects of the present disclosure;

FIG. 6 is a general process flow diagram showing the integration of ion exchange-based advanced treatment (XBAT) into a variety of possible treatment trains for potable reuse, according to some non-limiting embodiments or aspects of the present disclosure;

FIG. 7 is a general process flow diagram showing the integration of XBAT into one specific example treatment train proposed for direct potable reuse, according to some non-limiting embodiments or aspects of the present disclosure;

FIG. 8 is a schematic view of a system for generating bicarbonate solution, according to some non-limiting embodiments or aspects of the present disclosure;

FIG. 9 is a perspective view of another system for generating bicarbonate solution, according to some non-limiting embodiments or aspects of the present disclosure;

FIG. 10 is a view of a gas sparger in fluid communication with a reaction vessel of the system for generating bicarbonate solution, according to some non-limiting embodiments or aspects of the present disclosure;

FIG. 11 is a view of a graph displaying a relationship between elapsed sparge time and pH, and before sparge and after sparge alkalinity values, of various concentrations of sodium hydroxide solutions exposed to a carbon dioxide sparge, according to some non-limiting embodiments or aspects of the present disclosure; and

FIG. 12 is a view of multiple graphs displaying a relationship between elapsed sparge time and pH, and before sparge and after sparge alkalinity and conductivity values, of two concentrations of sodium hydroxide solutions exposed to a carbon dioxide sparge, according to some non-limiting embodiments or aspects of the present disclosure.

Corresponding reference characters indicate corresponding features throughout the several views of the drawings. The representations set out herein illustrate exemplary aspects of the disclosure, and such representations are not to be construed as limiting the scope of the disclosure in any manner.

### DETAILED DESCRIPTION

While this disclosure is made as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

Disclosed herein is an ion exchange system 10 for treating water and method for treating water. The disclosed system 10 and method utilize an ion exchange-based advanced treatment (XBAT) system and process. As used herein, the ion exchange system 10 for treating water and the method for treating water of the present disclosure may refer to the “XBAT” system and process. In general, the disclosed ion exchange system 10 and method can include the following unique components: (1) suspended ion exchange for removing dissolved organic matter (DOM) and inorganic anions (e.g., sulfate, phosphate, anionic perfluoroalkyl and polyfluoroalkyl substances (PFAS), bromide, nitrate, nitrite, chloride, etc.); (2) regenerating resin in-situ using bicarbonate counter ions; and (3) lime softening for hardness and further total dissolved solids (TDS) removal. Additional processes, such as granular media filtration (GMF) microfiltration or ultrafiltration (MF/UF), ozone (O₃) treatment, biological active filtration (BAF), biological activated carbon (BAC) treatment, granular activated carbon (GAC) treatment, ultraviolet (UV) treatment, ultraviolet advanced oxidation process (UV-AOP) treatment, chlorine contact treatment, and other advanced treatment processes, may be implemented following the disclosed ion exchange system 10 and method to achieve desired finished water quality for potable reuse. For example, a filtration process (e.g., GMF, MF, UF) can be used to control turbidity from lime softening, and advanced treatment processes (e.g., ozone, BAF, GAC) can be used to achieve additional water quality treatment goals.

In accordance with the above, in one example, the disclosed ion exchange system 10 and method can include suspended ion exchange for dissolved organic matter and inorganic anion (e.g., nitrate, nitrite, phosphate, sulfate, bromide, chloride, etc.) removal, in-situ resin regeneration using bicarbonate, and lime softening for hardness and further total dissolved solids (TDS) removal. As compared to other methods, such as reverse osmosis (RO)-based advanced treatment (RBAT), for treating water and wastewater, the ion exchange system 10 and method addresses chemical, and potentially pathogenic, contaminants without producing a large volume waste stream. For high salinity or high TDS source water, the status quo advanced treatment approach for potable reuse is RBAT. Although RO produces exceptional quality product water, this treatment process is energy-intensive and produces a large volume of RO concentrate (15 to 25% of the total feed flow), which is challenging and cost-prohibitive to dispose of.

In comparison to carbon-based advanced treatment (CBAT), the disclosed ion exchange system 10 and method provides multiple barriers for the removal of inorganic salts in addition to organic constituents and the disclosed ion exchange system 10 and method is capable of producing higher-quality product water. CBAT is a promising treatment alternative to RBAT in the control of pathogens and bulk as well as trace organic contaminants, but there is no treatment barrier for removing salinity. Salinity represents a specific challenge for water treatment because conventional physiochemical and biological processes do not remove dissolved salts.

The overall water quality improvements achieved and the waste produced by the disclosed ion exchange system 10 and method, in comparison to RBAT and CBAT, are listed below in Table 1.

TABLE 1

| | XBAT | | RBAT | | CBAT | |
|---|---|---|---|---|---|---|
| Water Quality | [symbol] | Pathogens | [symbol] | Pathogens | [symbol] | Pathogens |
| Improvements | [symbol] | Organics | [symbol] | Organics | [symbol] | Organics |
| | [symbol] | Salinity | [symbol] | Salinity | [symbol] | Salinity |
| | [symbol] | Constituents of emerging | [symbol] | CECs | [symbol] | CECs |
| | | concern (CECs) | | | | |
| Waste Produced | [symbol] | ≈0.8% concentrate | [symbol] | ≈7-15% concentrate | [symbol] | No appreciable waste products |

The disclosed ion exchange system 10 and method may be more accessible to communities that cannot use RBAT or CBAT due to limitations herein described. In one aspect, the disclosed ion exchange system 10 and method is more energy and water efficient than RBAT, with less than one percent of total feed flow as waste. Total dissolved solids (TDS) can be removed through the disclosed ion exchange system 10 and method by exchanging anions for bicarbonate, followed by precipitation and removal of the bicarbonate via lime softening. Conventional ion exchange (IX) treatment is often conducted in a fixed-bed configuration and uses a chloride-based regenerant, which results in elevated chloride concentrations in the product water as a result of ion exchange. This has adverse outcomes, such as increased corrosivity and salinity to treated waters. The disclosed ion exchange system 10 and method utilizing bicarbonate counter ions advantageously eliminates this issue. Furthermore, conventional lime softening used in drinking water treatment results in large volumes of solid residual that is difficult to manage. Lime softening could result in high softened water turbidity and thus the requirement for a filtration system downstream.

As discussed above, conventional ion exchange processes are characterized by contacting ion exchange resins with contaminated water in a fixed-bed contactor. This conventional treatment is a non-steady state process, and contaminant concentration in the treated effluent increases over time between resin regenerations. Unlike the conventional fixed-bed treatment process, the disclosed system 10 and method offers a steady state ion exchange process that keeps the ion exchange resins in suspension in a semi-plug flow reactor. After a relatively short contact time, the used resins continuously flow out of the reactor and are collected and separated by a resin separator, such as a plate settler. The spent resins can then be regenerated using a concentrated regenerant. Following regeneration, resins can then be rinsed and stored in a resin holder, such as a fresh resin storage vessel, before being metered back to the front of the ion exchange system 10 for treating water. This high regeneration frequency keeps the ion exchange capacity of the resin only slightly utilized, thus requiring a much lower concentration regenerant as compared to the conventional resin regeneration process.

Ion exchange is a reversible process that removes contaminants from water through the exchange of ions between solid and liquid phases. In water treatment, dissolved organic matter (DOM), often characterized by dissolved organic carbon (DOC), may be effectively removed by strong base anion (SBA) exchange resins because DOM is negatively charged. In addition to DOC, SBA exchange resins also remove other anionic constituents, including nitrate (NO₃⁻), nitrite (NO₂⁻), sulfate (SO₄²⁻), bicarbonate (HCO₃⁻), phosphate (PO₄³⁻), chloride (Cl⁻), bromide (Br⁻), and others. Chloride can be removed if bicarbonate is used as a regenerant. Similarly, bicarbonate can be removed if chloride is used as a regenerant.

Another conventional process for removing contamination from water may include a magnetic ion exchange process, which is commonly utilized for full-scale drinking water treatment upstream of coagulation, flocculation, and sedimentation, for the removal of DOC. Compared to the magnetic ion exchange process, the use of SBA resins (e.g., non-magnetic resins) in a suspended ion exchange process makes the disclosed treatment system 10 and method much more accessible and economical for water treatment. Additional advantages of using the suspended ion exchange system 10 and method, versus the magnetic ion exchange process, includes less resin attrition, minimal resin carryover to downstream treatment processes, and regeneration of the entire resin inventory with a lower concentration regenerant.

Accordingly, another advantage to the disclosed system 10 and method is its high resin regeneration frequency, such that the entire resin inventory is regenerated after every single pass through the reactor. This high regeneration frequency keeps the resin's ion exchange capacity only slightly utilized, thus requiring a lower concentration regenerant as compared to conventional resin regeneration processes (e.g., 2% solution concentration by weight versus 10% solution concentration by weight for sodium chloride). As a result, suspended ion exchange produces a less concentrated waste stream. Further, the disclosed system 10 and method requires a much lower brine concentration than conventional fixed-bed ion exchange or magnetic ion exchange processes. The disclosed feature of lower regenerant concentration allows bicarbonate regeneration to be effectively used, and other ion exchange technologies may not be suitable because they require higher regenerant concentration.

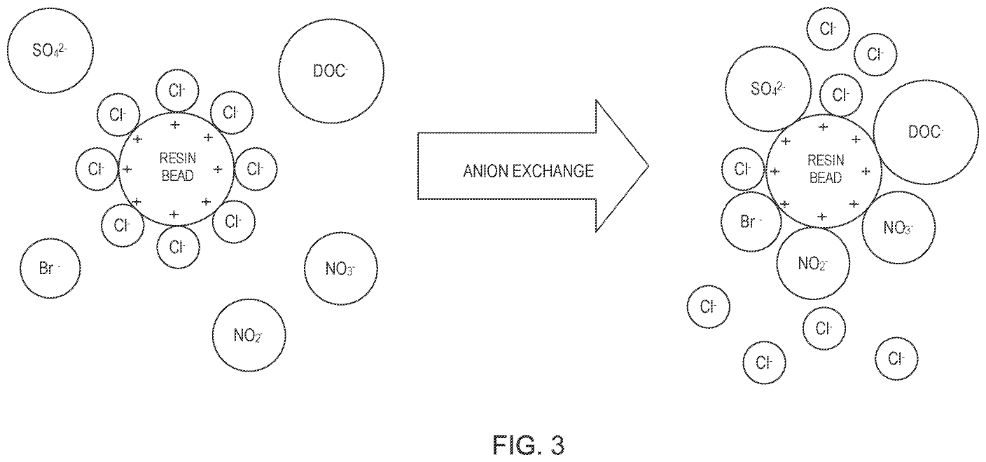

Typically, anion exchange resins use chloride as the counter ion and are referred to as chloride-form resins. Chloride is used as the counter ion is because it is relatively inert with respect to water chemistry reactions and the cost of sodium chloride (NaCl) salt is low. However, elevated chloride concentration as a result of ion exchange has adverse outcomes, such as increased corrosivity and salinity to treated waters. An increase in chloride to sulfate mass ratio (CSMR) can increase lead corrosion potential in distribution systems. Chloride-form anion exchange resins are expected to increase the CSMR not only by releasing chloride but also by removing sulfate. Chloride-form anion exchange resins also present challenges related to waste regenerant disposal. Due to its high salinity, discharge of NaCl-based waste regenerant to wastewater treatment plants requires a large dilution and can adversely impact biological treatment performance and the ability to reuse the treated wastewater. Waste regenerant disposal also imposes practical and financial challenges when ocean discharge is inaccessible and deep well injection is not permittable. Adverse outcomes associated with use of chloride-form anion exchange resins is explained below in relation to FIG. 3.

Referring to FIG. 3, there is shown a view of an ion exchange resin undergoing ion exchange with chloride as the counter ion, according to some non-limiting embodiments or aspects of the present disclosure. As discussed above, FIG. 3 shows an anion exchange resin using chloride as the counter ion. Because the resin bead binds sulfate anions and releases chloride anions, the treated effluent has an increased chloride to sulfate mass ratio (CSMR) as shown in FIG. 3. However, elevated chloride concentration as a result of ion exchange has adverse outcomes, such as enhanced corrosivity and increased salinity to treated waters, which represents a specific challenge for potable reuse because municipal wastewater is already elevated in salinity compared to conventional drinking water supplies. Furthermore, an increase in chloride to sulfate mass ratio (CSMR) can increase lead corrosion potential in distribution systems. Chloride-form anion exchange resins are expected to increase the CSMR not only by releasing chloride but also by removing sulfate. Finally, chloride-form anion exchange resins present challenges related to waste regenerant disposal for the reasons discussed above.

Accordingly, one way to minimize the problems associated with chloride-form anion exchange resins is to use bicarbonate (HCO₃⁻), which is a more benign counter ion, as the counter ion in anion exchange reactions. Bicarbonate-form anion exchange resin exhibits a similar and sometimes better affinity compared to chloride-form anion exchange resin for sulfate, nitrate, and DOC. Moreover, bicarbonate may be as effective as chloride in regenerating ion exchange process resin.

Resin regeneration with bicarbonate in the disclosed system 10 and method may yield improved results. Bicarbonate regeneration decreases chloride concentrations and corrosivity and increases alkalinity of the treated water. The disclosed system 10 and method is well-suited for bicarbonate regeneration due to its requirement for low concentration regenerant. Bicarbonate regeneration in ion exchange applications was previously limited due to the relatively low NaHCO₃ solubility in water (i.e., 90 g NaHCO₃/L vs. 360 g NaCl/L at 20° C.). For this reason, the much lower regenerant concentration required by the disclosed system 10 and method makes bicarbonate regeneration more feasible.

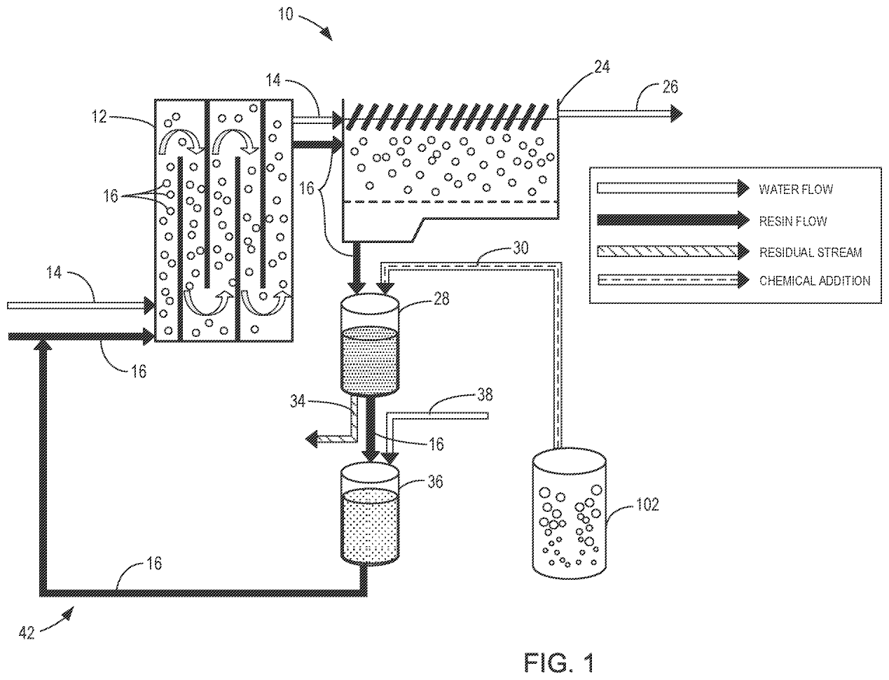

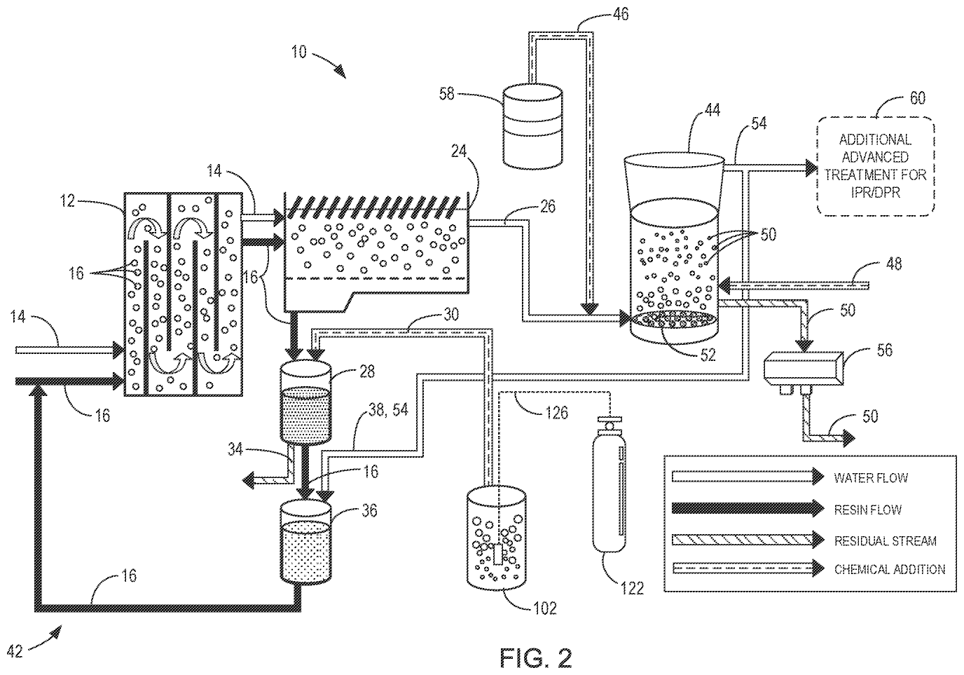

Referring to FIG. 1, there is shown a view of an ion exchange system 10 for treating water, according to some non-limiting embodiments or aspects of the present disclosure. Referring to FIG. 2, there is shown a view of another ion exchange system 10 for treating water, according to some non-limiting embodiments or aspects of the present disclosure.

Referring to FIGS. 1 and 2, the present disclosure relates to an ion exchange system 10 for treating water. The water can be wastewater, such as municipal wastewater effluent, or any water that has undesirable total dissolved solids therein. The system 10 can include a semi-plug flow reactor 12 having an inflow of water 14 and ion exchange resin 16. The semi-plug flow reactor 12 can be any reactor that has characteristics of the plug flow reactor. The plug flow reactor is an idealized model of a flow reactor with theoretical “plugs” moving in the direction of the flow at the same speed. Generally, each plug can have a uniform composition that is different from the plug before it and different from the plug after it. As used herein, the term “inflow” may refer to an amount of a liquid, a gas, or a solid that moves or is transferred into place. For example, an inflow of ion exchange resin 16 can include an amount of solid ion exchange resin 16 that moves or is transferred into place.

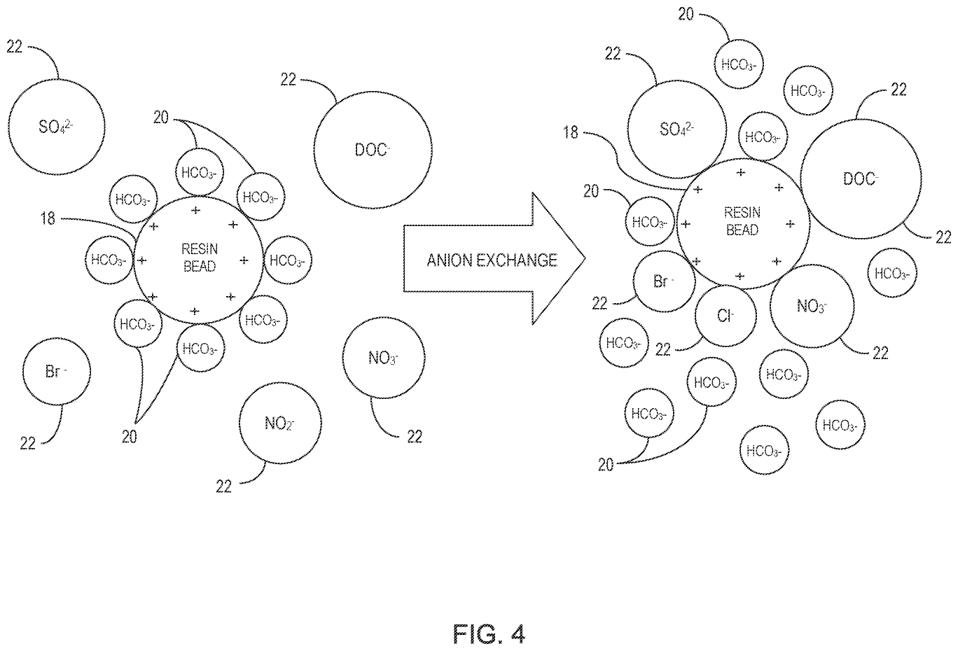

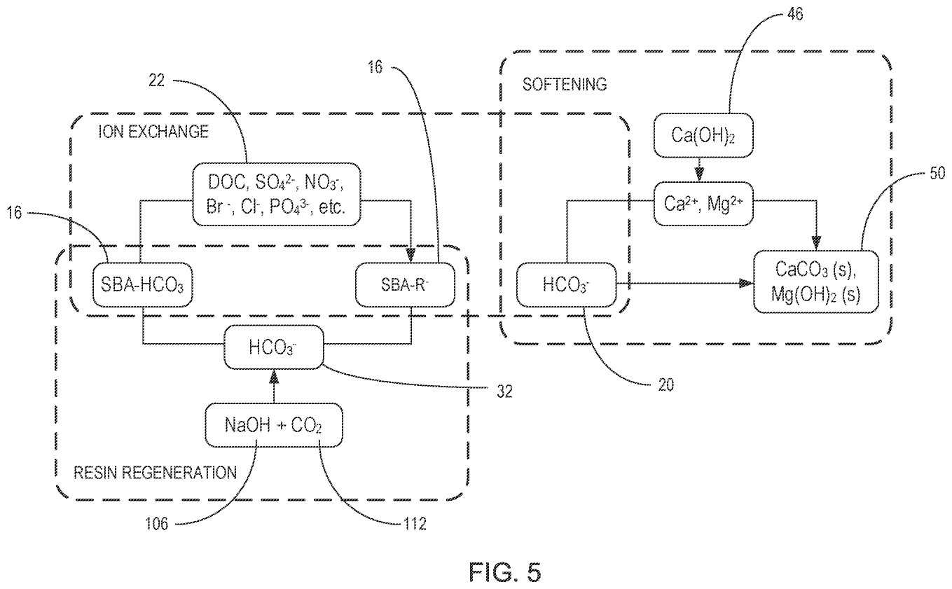

Referring to FIG. 4, there is shown a view of an ion exchange resin 16 undergoing ion exchange with bicarbonate as the counter ion, according to some non-limiting embodiments or aspects of the present disclosure. Referring to FIG. 5, there is shown a view of the processes of ion exchange, bicarbonate regeneration, and softening and a diagram of the relationship between the chemical reactions utilized in ion exchange, bicarbonate regeneration, and softening processes, according to some non-limiting embodiments or aspects of the present disclosure. The ion exchange resin 16 includes a positively charged resin bead 18 and counter ions 20 bonded to the resin bead 18. The ion exchange resin 16 can be a strong base anion (SBA) exchange resin. As discussed above, the ion exchange resin 16 can be a bicarbonate-form anion exchange resin. Specifically, as shown in FIG. 4, the counter ion 20 can be bicarbonate (HCO₃⁻). The ion exchange resin 16 can have an insoluble polymeric/resin bead that acts as a support structure for binding ions. The polymeric bead or resin bead 18 can be porous, which provides a large surface area for binding ions on the exterior surface thereof and the interior surface of the pores. As discussed above, the high regeneration frequency of the ion exchange resin 16, which keeps the ion exchange capacity of the ion exchange resin 16 only slightly utilized, results in the benefit of limiting organic foulants from penetrating as deep into the resin beads 18. The water 14 includes at least one contaminant anion 22 dissolved therein. As shown in at least FIG. 4 and FIG. 5, the contaminant anions 22 can include at least one of the following: dissolved organic carbon (DOC), nitrate (NO₃⁻), nitrite (NO₂⁻), sulfate (SO₄²⁻), bicarbonate (HCO₃⁻), phosphate (PO₄³⁻), chloride (Cl⁻), bromide (Br⁻), anionic perfluoroalkyl and polyfluoroalkyl substances (PFAS), or any combination thereof. Bicarbonate-form anion exchange resin exhibits a similar and sometimes better affinity as chloride-form anion exchange resin for sulfate, nitrate, and DOC. Moreover, bicarbonate may be as effective as chloride in regenerating ion exchange process resin.

Referring to FIGS. 1, 2, 4, and/or 5, the semi-plug flow reactor 12 is configured to allow a continuous, semi-plug flow of the water 14 and the ion exchange resin 16 through and out of the semi-plug flow reactor 12. The ion exchange resin 16 is suspended in the water 14 and can exchange one or more of the counter anion(s) 20 with one or more of the contaminant anion(s) 22 in the water 14 during the flow through and out of the semi-plug flow reactor 12. For example, through contact and mixing of the ion exchange resin 16 and the water 14 during the flow through and out of the semi-plug flow reactor 12, the resin bead 18 of the ion exchange resin 16 can bind one or more of the contaminant anion(s) 22 and release a bond of one or more of the counter anion(s) 20. As discussed above, unlike the conventional fixed-bed treatment process, the disclosed system 10 and method keeps the ion exchange resin 16 in suspension in a semi-plug flow reactor. After a relatively short contact time, the used ion exchange resin 16 continuously flows out of the semi-plug flow reactor 12.

Referring to FIGS. 1, 2, 4, and/or 5, the ion exchange system 10 for treating water can include a resin separator 24 in fluid communication with the semi-plug flow reactor 12. The resin separator 24 includes an inflow of the water 14 and the ion exchange resin 16 from the semi-plug flow reactor 12. The resin separator 24 can be a plate settler. Specifically, the resin separator 24 can be a lamella clarifier or an inclined plate settler (IPS). The resin separator 24 is configured to separate at least a portion of the water 14 from the ion exchange resin 16. The separated portion of the water 14 includes a treated effluent 26. The treated effluent 26 includes one or more of the counter anion(s) 20 therein. For example, each contaminant anion 22 that becomes bound to the resin bead 18 is separated from the water 14 and each counter anion 20 released from the resin bead 18 becomes dissolved in the water 14 thus establishing the treated effluent 26 stream.

If the resin separator 24 is a lamella clarifier or an inclined plate settler (IPS), the resin separator 24 can include a body and a plurality of inclined plates positioned in the body. The body can include an inlet at the top of the body and a feed channel in fluid communication with a bottom of the body. The inlet can receive the inflow of the water 14 and the inflow of the ion exchange resin 16. The water 14 and the ion exchange resin 16 are configured to flow down the feed channel to the bottom of the body and underneath the inclined plates. The lamella clarifier or inclined plate settler is configured to generate an upward flow of the water 14 and the ion exchange resin 16 inside the body and between the inclined plates. During the upward flow of the water 14 and the ion exchange resin 16, the ion exchange resin 16 settles onto the inclined plates and falls to the bottom of the body, while the water 14 exits the resin separator 24 as treated effluent 26 from an outlet above the inclined plates. As shown in FIGS. 1 and 2, the separated ion exchange resin 16 can be discharged from the bottom of the resin separator 24 after settling.

Referring to FIGS. 1, 2, 4, and/or 5, the ion exchange system 10 can include a resin regeneration vessel 28 in fluid communication with the resin separator 24. The resin regeneration vessel 28 can include an inflow of the ion exchange resin 16 from the resin separator 24 and an inflow of a regenerant solution 30. The resin regeneration vessel 28 can be any vessel or tank capable of holding and generating contact between the ion exchange resin 16 and the regenerant solution 30. For example, the resin regenerator 28 can be a batch reactor or a plug flow reactor. The resin regeneration vessel 28 allows contact between the ion exchange resin 16 and the regenerant solution 30. The regenerant solution 30 can include at least one regenerant anion 32 dissolved therein. As shown in FIG. 5, the at least one regenerant anion 32 can be bicarbonate (HCO₃⁻) and the regenerant solution 30 can be a bicarbonate solution. The ion exchange resin 16 can exchange one or more of the contaminant anion(s) 22 with one or more of the regenerant anion(s) 32 dissolved in the regenerant solution 30. For example, through contact and mixing of the ion exchange resin 16 and the regenerant solution 30 in the resin regeneration vessel 28, the resin bead 18 of the ion exchange resin 16 can bind one or more of the regenerant anion 32, and the resin bead 18 can release the bond of one or more of the contaminant anion 22 that was established during the flow through and out of the semi-plug flow reactor 12. The resin regeneration vessel 28 is configured to separate a waste regenerant solution 34 from the ion exchange resin 16. The waste regenerant solution 34 includes one or more of the contaminant anion 22 therein. For example, each regenerant anion 32 that becomes bound to the resin bead 18 is separated from the regenerant solution 30 and each contaminant anion 22 released from the resin bead 18 becomes dissolved in the regenerant solution 34, thus establishing the waste regenerant solution 34 stream.

Referring to FIGS. 1 and 2, the ion exchange system 10 for treating water can include a resin holder 36 in fluid communication with the resin regeneration vessel 28. The resin holder 36 can include an inflow of the ion exchange resin 16 from the resin regeneration vessel 28 and an inflow of rinse water 38. The resin holder 36 can be a vessel or tank, such as a resin storage vessel. Specifically, the resin holder 36 can be any vessel or tank capable of holding and allowing contact between the ion exchange resin 16 and the rinse water 38. For example, the resin holder 36 can have the characteristics of a reactor vessel and can include a mixer or agitator configured to mix and suspend the ion exchange resin 16 within the rinse water 38. The resin holder 36 is configured to hold the ion exchange resin 16 in suspension within the rinse water 38 as a slurry for easier return or transport to the semi-plug flow reactor 12, as will be discussed below.

Referring to FIGS. 1 and 2, the ion exchange system 10 for treating water can include a resin return line 42 in fluid communication with the resin holder 36. The resin return line 42 can be a pipe or network of pipes. The resin return line 42 is configured to return the ion exchange resin 16 to the semi-plug flow reactor 12. The resin return line 42 can be in direct fluid communication with the semi-plug flow reactor 12 or indirect fluid communication with the semi-plug flow reactor by, for example, returning the ion exchange resin 16 to a line or pipe used to introduce the inflow of the water 14 to the semi-plug flow reactor 12. Returning the ion exchange resin to the semi-plug flow reactor 12 can include metering the ion exchange resin 16, for example within the rinse water 38 as a slurry, to the reactor or controlling a rate of return of the ion exchange resin 16 to the reactor. Thus, the resin return line 42 can include a meter or instrument that measures the rate of return of the ion exchange resin 16 to the semi-plug flow reactor 12, and the resin return line 42 can include any components that control or regulate the flow of the ion exchange resin 16.

Unlike the conventional fixed-bed adsorbers, the ion exchange system 10 for treating water offers a steady-state ion exchange process that keeps the ion exchange resin 16 in suspension in the semi-plug flow reactor 12. After a relatively short contact time in the semi-plug flow reactor 12, the ion exchange resin 16 continuously flows out of the semi-plug flow reactor 12 and is subsequently collected and separated by the resin separator 24. The ion exchange resin 16 may then be regenerated using the regenerant solution 30. Following regeneration, the ion exchange resin 16 may be rinsed and stored in the resin holder 36 before being returned or metered back to the semi-plug flow reactor 12 or the front of the suspended ion exchange process, as discussed above. Importantly, the steady state of the ion exchange system 10 for treating water and the high regeneration frequency of the ion exchange resin 16 keeps the ion exchange capacity of the ion exchange resin 16 only slightly utilized, thus requiring a much lower concentration regenerant solution 30 as compared to the conventional resin regeneration processes.

Referring to FIG. 2, in one embodiment, the ion exchange system 10 for treating water can include a softening reactor 44 in fluid communication with the resin separator 24. The softening reactor 44 can include an inflow of the treated effluent 26 from the resin separator 24, an inflow of calcium hydroxide (Ca(OH)₂) 46, and an inflow of a seeding material 48. The softening reactor 44 is configured to generate an upward flow of the treated effluent 26, the calcium hydroxide 46, and the seeding material therein 48. The softening reactor 44 can be a pellet softening reactor. Specifically, the softening reactor 44 can be an upflow fluidized reactor. The seeding material 48 can include at least one of the following: calcium carbonate pellets, sand, limestone, garnet, or any combination thereof.

As described above, the treated effluent 26 includes one or more of the counter anion 20 dissolved therein. Referring to FIGS. 2 and 5, the counter anion(s) 20 dissolved in the treated effluent 26 and the calcium hydroxide 46 react and form a precipitated solid 50 on a surface of the seeding material 48 in the treated effluent 26. The seeding material can provide a support surface upon which the precipitated solid 50 can form. The precipitated solid 50 can settle in the treated effluent 26 to a bottom 52 of the softening reactor 44. As shown in FIG. 5, the precipitated solid 50 can be calcium carbonate (CaCO₃).

The treated effluent can include magnesium ions (Mg²⁺) dissolved therein. If the treated effluent 26 includes magnesium-hardness by having magnesium ions (Mg²⁺) therein, a conventional solids contact clarifier (not shown) can be used to remove the magnesium-hardness. As shown in FIG. 5, the magnesium-hardness can be removed by precipitating magnesium hydroxide (Mg(OH)₂) in a solids contact clarifier.

Referring to FIG. 2, the softening reactor 44 is configured to separate at least a portion of the treated effluent 26 from the precipitated solid 50. The separated portion of the treated effluent 26 includes a treated and softened effluent 54. In one embodiment, as shown in FIG. 2, the softening reactor 44 can be in fluid communication with the resin holder 36. The softening reactor 44 can be in fluid communication with the resin holder 36 via an effluent return line. The effluent return line can be a pipe or network of pipes. In this way, the inflow of the rinse water 38 into the resin holder 36 can include the treated and softened effluent 54 separated from the softening reactor 44. By using at least a portion of the treated and softened effluent 26 as the rinse water 38, the overall water consumption of the ion exchange system 10 for treating water is decreased.

The softening reactor 44 is also configured to remove the precipitated solid 50 settled therein. The ion exchange system 10 for treating water can include a hopper 56 in fluid communication with the softening reactor 44. The hopper 56 includes an inflow of the precipitated solids 50 from the softening reactor 44. The hopper 56 is configured to hold, dry, and dispense the precipitated solids 50. In one example, the CaCO₃ precipitated solids 50 or pellets may be used as a nutrient additive in agricultural applications, as a cattle feedstock, as a whitening agent in concrete production, or for drywall. In another example, the CaCO₃ precipitated solids 50 or pellets may also be ground into finer particles and reused as seeding material 48 for subsequent pellet softening.

Referring to FIG. 2, the ion exchange system 10 can include a calcium hydroxide holding vessel 58 in fluid communication with the softening reactor 44 and in-line with the inflow of the calcium hydroxide 46. The calcium hydroxide holding vessel can be any vessel or tank that is capable of holding and introducing the calcium hydroxide 46 to the softening reactor 44. The calcium hydroxide 46 can be in a liquid solution in the holding vessel 58. When the calcium hydroxide 46 contained in the calcium hydroxide holding vessel 58 is provided to the softening reactor 44, it mixes with the treated effluent 26 so as to dilute the calcium hydroxide 46 concentration such that its solubility limit is not exceeded in the treated effluent 26.

Utilizing the softening reactor 44 in the ion exchange system 10 for treating water can be considered pellet softening. Compared to conventional softening using solids contact clarifiers, pellet softening is hydraulically different. Utilizing the softening reactor 44 through pellet softening is advantageous in that it produces free-draining solid pellets at a high rate.

Utilizing the softening reactor 44 through pellet softening produces water of low turbidity and generates a main byproduct, calcium carbonate, that presents a potential resource, as described above, for beneficial reuse. As described above, the treated effluent 26 is treated in a softening reactor 44, such as an upflow fluidized reactor, where the calcium hydroxide 46 or lime, as a basic material, and the seeding material 48 (e.g., calcium carbonate pellets, sand, limestone, and/or garnet) can be introduced into an upper portion of the reactor and initiate CaCO₃ precipitation as the precipitated solids 50 onto the surface of the seeding material 48, thereby forming pellets. The calcium hydroxide 46 or lime addition adds calcium, increases water pH and initiates CaCO₃ precipitation onto the surface of the seeding material 48, thereby increasing pellet size of the precipitated solids 50. As the pellet size of the precipitated solids 50 increase and become heavier, they gravitate towards the bottom of the softening reactor 44 where the precipitated solids 50 are periodically removed. The specific use of calcium hydroxide 46 or lime in lieu of other bases, such as sodium hydroxide, in the softening process is beneficial to TDS reduction by eliminating sodium addition. Calcium can be initially added due to lime dosing, but it is subsequently removed in the form of CaCO₃ precipitated solids 50 as described above.

In another embodiment, the ion exchange system 10 for treating water can include conventional softening techniques instead of utilizing the softening reactor 44 and pellet softening. Utilizing conventional softening techniques instead of utilizing the softening reactor 44 and pellet softening depends on the source water 14 quality and the treated water quality goals. Nonetheless, coupling the ion exchange system 10 with the softening reactor 44 and pellet softening leverages excess alkalinity to remove TDS from the source water.

Referring to FIGS. 2, 6, and 7, the ion exchange system 10 for treating water can include at least one advanced treatment system 60 for treating water. The at least one advanced treatment system 60 can be in fluid communication with the softening reactor 44. The at least one advanced treatment system 60 can include an inflow of the treated and softened effluent 54 separated from the softening reactor 44. The at least one advanced treatment system 60 can include at least one of the following: microfiltration (MF), ultrafiltration (UF), granular media filtration (GMF), ozone (O₃) treatment, biological activated carbon (BAC) treatment, biological active filtration (BAF), granular activated carbon (GAC) treatment, ultraviolet light (UV) treatment, ultraviolet light-advanced oxidation process (UV-AOP) treatment, chlorine contact treatment, or any combination thereof as needed in order to meet prescribed treated water quality targets. That is, additional processes, such as GMF, MF/UF, ozone, BAF, GAC, and other advanced treatment processes, may be implemented following the ion exchange system 10 for treating water to achieve desired, finished water quality.

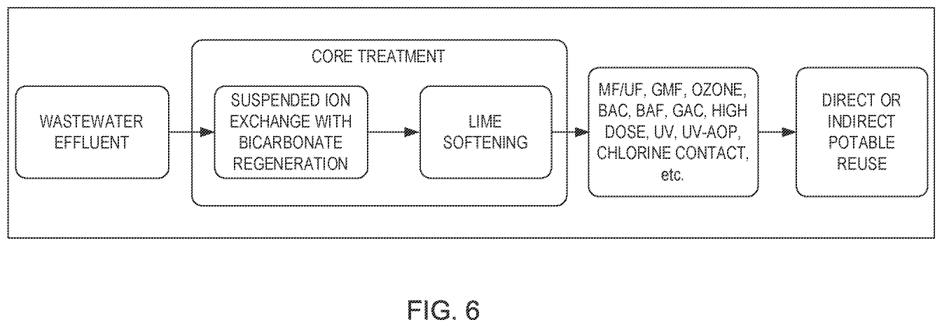

FIG. 6 is a general process flow of treating water using the ion exchange system 10, according to some non-limiting embodiments or aspects of the present disclosure. As shown in FIG. 6, the ion exchange system 10 for treating water can yield either direct potable reuse or indirect potable reuse. The water 14, such as wastewater effluent, can first undergo suspended ion exchange with bicarbonate regeneration followed by lime softening. The suspended ion exchange with bicarbonate regeneration and the lime softening can be considered as the core treatment processes in the ion exchange system 10 for treating water. After the core treatment processes, the water can undergo treatment in at least one of the following advanced treatment systems 60: microfiltration (MF), ultrafiltration (UF), granular media filtration (GMF), ozone (O₃) treatment, biological activated carbon (BAC) treatment, biological active filtration (BAF), granular activated carbon (GAC) treatment, ultraviolet light (UV) treatment, ultraviolet light-advanced oxidation process (UV-AOP) treatment, chlorine contact treatment, or any combination thereof.

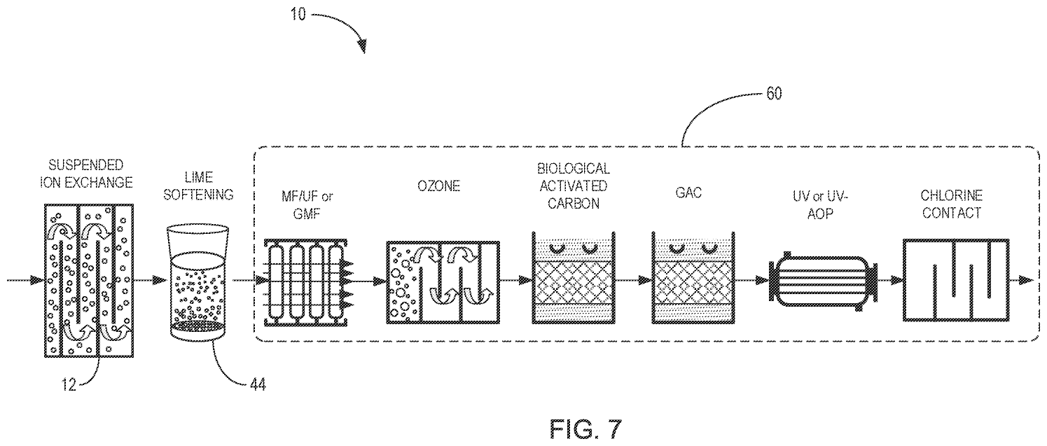

Referring to FIG. 7, there is shown a general process flow of treating water using the ion exchange system 10 for direct potable reuse (DPR), according to some non-limiting embodiments or aspects of the present disclosure. That is, FIG. 7 illustrates an example of a conceptual direct potable reuse system and method that integrates the disclosed ion exchange system 10 for treating water as a pretreatment step. In this example, the ion exchange system 10 for treating water includes suspended ion exchange utilizing the semi-plug flow reactor 12, lime softening utilizing the softening reactor 44, and advanced treatment systems 60 including MF/UF or GMF, ozone treatment, BAF or BAC, UV or UV-AOP treatment, and chlorine disinfection.

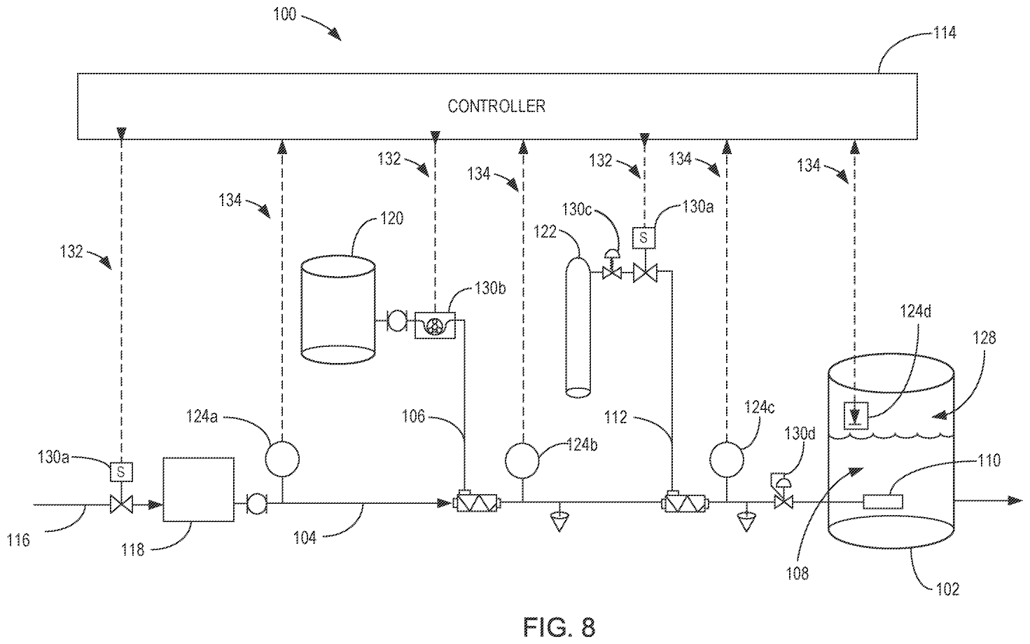

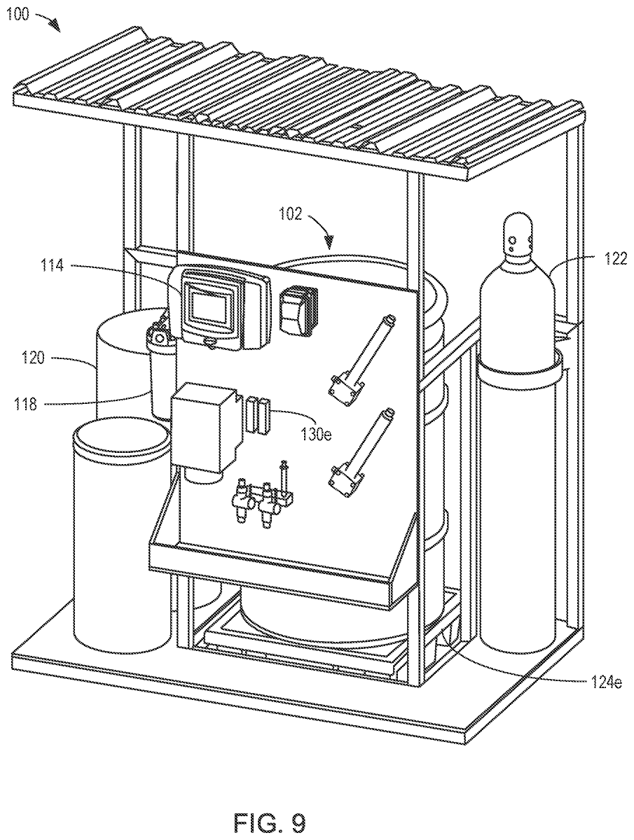

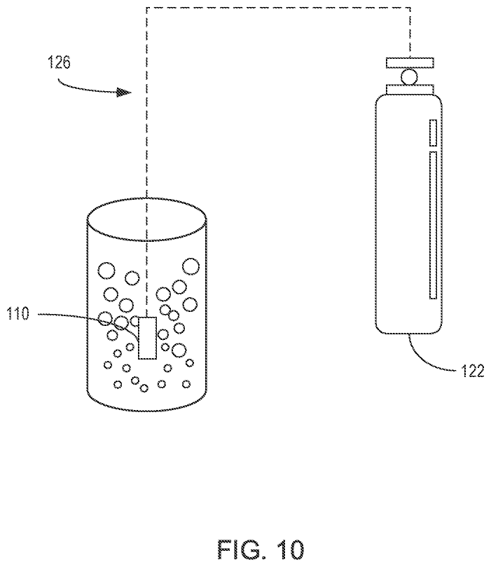

The ion exchange system 10 for treating water can include a system 100 for generating the bicarbonate solution, as the regenerant solution 30. Referring to FIG. 8, there is shown a view of a system 100 for generating bicarbonate solution, according to some non-limiting embodiments or aspects of the present disclosure. Referring to FIG. 9, there is shown a perspective view of a system 100 for generating bicarbonate solution, according to some non-limiting embodiments or aspects of the present disclosure. Referring to FIG. 10, there is shown a view of a gas sparger 110 in fluid communication with a reaction vessel 102, according to some nonlimiting embodiments or aspects of the present disclosure.

Referring to FIGS. 8-10, the system 100 for generating bicarbonate solution includes a reaction vessel 102 having an inflow 104 of water and an inflow 106 of sodium hydroxide (NaOH). The water and the sodium hydroxide combine to form a solution 108 in the reaction vessel 102. The system 100 for generating bicarbonate solution also includes a gas sparger 110 in fluid communication with the reaction vessel 102. The gas sparger 110 provides an inflow 112 of gas including carbon dioxide (CO₂), such as a gas that is pure or nearly pure (e.g., 95% or more such as 99% or more CO₂), into the solution 108 in the reaction vessel 102. In one embodiment, inflow 104, inflow 106, and inflow 112 all enter the reaction vessel 102 through the same inlet and may be combined prior to entering the reaction vessel 102. In another embodiment, inflow 104, inflow 106, and inflow 112 each enter the reaction vessel 102 through a different inlet, such as their own respective inlets, and are not combined or mixed prior to entering the reaction vessel 102. In yet another embodiment, inflow 104 and inflow 106 enter the reaction vessel through the same inlet, while inflow 112 enters the reaction vessel 102 through a different inlet. The sodium hydroxide and the carbon dioxide react to form at least bicarbonate (HCO₃⁻) in the solution 108. As used herein, the term “inflow” may refer to an amount of a liquid, a gas, or a solid that moves or is transferred into place. For example, an inflow of sodium hydroxide can include an amount of liquid sodium hydroxide solution that moves or is transferred into place. In another embodiment, an inflow of sodium hydroxide can include an amount of solid sodium hydroxide that moves or is transferred into place.

The gas sparger 110 can be any device that is capable of introducing the carbon dioxide gas to the solution 108 in the reaction vessel 102. As shown in FIGS. 8 and 10, the gas sparger 110 can be positioned in the solution 108 in the reaction vessel 102. With the gas sparger 110 positioned in the solution in the reaction vessel 102, the carbon dioxide gas directly contacts the solution 108 and agitates the solution 108 during introduction. The gas sparger 110 can be designed and utilized to increase the interaction of the inflow 112 of the carbon dioxide gas and the solution 108 in the reaction vessel. In one embodiment, the gas sparger 110 can include a feed pipe and an injector or a nozzle at the end of the feed pipe. The injector or nozzle can include an opening or pores that allow the carbon dioxide gas to exit the feed pipe and contact the solution 108 in the reaction vessel 102. In some non-limiting embodiments, the gas sparger 110 includes numerous small pores that create bubbles containing carbon dioxide gas that are introduced into the solution 108. In another embodiment, the system 100 for generating bicarbonate solution can include multiple gas spargers 110 in fluid communication with the reaction vessel 102.

Referring to FIGS. 8 and 9, the system 100 for generating bicarbonate solution can include a controller 114 in communication with the inflow 104 of the water, the inflow 106 of the sodium hydroxide, and the inflow 112 of the carbon dioxide gas. In one embodiment, the controller 114 can be a computing device. The computing device can be one or more electronic device(s) that is/are configured to process data. Each computing device can include a processor, a user interface, an input device, a display, a memory, a network interface, etc. That is, each computing device can include any components necessary to receive, store, process, and/or output data.

As used herein, the phrase “in communication” may refer to a relationship capable of reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

The controller 114 can be configured to control a flow of the inflow 104 of the water, a flow of the inflow 106 of the sodium hydroxide, and a flow of the inflow 112 of the carbon dioxide gas. In one embodiment, the system 100 can include one or more flow regulating component(s) 130. The system 100 for generating bicarbonate solution can include at least one flow regulating component 130 upstream from the reaction vessel 102 and in-line with at least one of the following: the inflow 104 of the water, the inflow 106 of the sodium hydroxide, the inflow 112 of the carbon dioxide gas, or any combination thereof. Specifically, the system 100 for generating bicarbonate solution can include at least one flow regulating component 130a upstream from the reaction vessel 102 and in-line with the inflow 104 of the water, at least one flow regulating component 130b upstream from the reaction vessel 102 and in-line with the inflow 106 of the sodium hydroxide, and at least one flow regulating component 130a, 130c, 130d, 130e upstream from the reaction vessel 102 and in-line with the inflow 112 of the carbon dioxide gas. The controller 114 can be in communication with the at least one flow regulating component 130, 130a, 130b via a first communication connection 132.

Each flow regulating component 130, 130a, 130b can be a valve, a pump, a rotameter, a nozzle, a solids feeder, a flow meter, etc. Flow regulating component 130a can be a solenoid valve, flow regulating component 130b can be a pump, flow regulating component 130c can be a pressure regulator valve, flow regulating component 130d can be a back pressure valve, and flow regulating component 130e can be a rotameter. Solenoid valve 130a that is in-line with the inflow 104 of the water can allow the water to enter the system 100 from a water supply 116. The inflow 104 of the water can also include a flow meter (not shown) that measures the incoming flow of the water. Solenoid valve 130a that is in-line with the inflow 112 of the carbon dioxide gas can allow the carbon dioxide gas to enter the system 100 from a pressure vessel 122. Pump 130b that is in-line with the inflow 106 of the sodium hydroxide can allow the sodium hydroxide to enter the system 100 from a sodium hydroxide holding vessel 120. Pressure regulator valve 130c that is in-line with the inflow 112 of the carbon dioxide gas can regulate the pressure of the carbon dioxide gas entering the solenoid valve 130a from the pressure vessel 122. Back pressure valve 130d that is in-line with the inflow 112 of the carbon dioxide gas can apply a back pressure to the inflow 112 of the carbon dioxide gas in order to increase carbon dioxide solubility in the solution 108 in the reaction vessel 102. Rotameter 130e (shown in FIG. 9) that is in-line with the inflow 112 of the carbon dioxide gas can regulate the flowrate of the carbon dioxide gas entering the reaction vessel 102.

The controller 114 can be configured to control the flow of the inflow 104 of the water, the flow of the inflow 106 of the sodium hydroxide, and the flow of the inflow 112 of the carbon dioxide gas by, for example, communicating with the at least one flow regulating component 130, 130a, 130b via the first communication connection 132. In one embodiment, each of the inflow 104 of the water, the inflow 106 of the sodium hydroxide, and the inflow 112 of the carbon dioxide gas can include a flow regulating component 130, 130a, 130b, and the controller 114 can communicate with each flow regulating component 130, 130a, 130b via a first communication connection 132 for each flow regulating component 130, 130a, 130b. The controller 114 can communicate with each flow regulating component 130, 130a, 130b by, for example, increasing or decreasing a flow rate through the flow regulating component 130, 130a, 130b and/or permitting or stopping a flow through the flow regulating component 130, 130a, 130b. The controller 114 can communicate with each flow regulating component 130, 130a, 130b by, for example, transmitting data to each flow regulating component 130, 130a, 130b thereby increasing or decreasing a flow rate through the flow regulating component 130, 130a, 130b and/or permitting or stopping a flow through the flow regulating component 130, 130a, 130b via the first communication connection 132.

The system 100 for generating bicarbonate solution can include a water supply 116 upstream from the reaction vessel 102 and in-line with at least the inflow 104 of the water. The water supply 116 can include a feed line/pipe or a holding tank.

The system 100 for generating bicarbonate solution can include a water softener 118 upstream from the reaction vessel 102 and in-line with at least the inflow 104 of the water. The water softener 118 can be configured to soften the water before the inflow 104 into the reaction vessel 102. The water softener 118 can be any device that is capable of removing calcium (Ca²⁺), magnesium (Mg²⁺), and other metal ions from the water supply 116 before the inflow 104 into the reaction vessel 102. In one non-limiting example, the water softener 118 can include cation exchange resin beads having sodium counter ions. The sodium ions are exchanged with calcium and magnesium ions in the water supply 116 to remove those minerals from the water supply 116.

The system 100 for generating bicarbonate solution can include a sodium hydroxide holding vessel 120 upstream from the reaction vessel 102 and in-line with at least the inflow 106 of the sodium hydroxide. The sodium hydroxide can be in a liquid solution in the holding vessel 120, such as in a concentrated liquid solution with a high amount of sodium hydroxide (e.g., a % by mass of sodium hydroxide that is higher than the % by mass of sodium hydroxide in solution 108). In one embodiment, the liquid solution is between 30 and 60% by mass, such as 50% by mass, of sodium hydroxide. When the sodium hydroxide solution contained in the sodium hydroxide holding vessel 120 is provided to the reaction vessel 102, it mixes with water from water supply 116 so as to dilute the sodium hydroxide content in solution 108 to a target value, such as a value of between 1% and 5% by mass, or between 2% and 4% by mass, of sodium hydroxide.

The system 100 for generating bicarbonate solution can include a pressure vessel 122 upstream from the gas sparger 110 and in-line with at least the inflow 112 of the carbon dioxide gas. The pressure vessel 122 can be configured to hold the carbon dioxide gas, which may be in liquid form if maintained under sufficient pressure in the pressure vessel 122. The pressure vessel 122 can be configured to hold the carbon dioxide gas at a pressure that is greater than an ambient pressure, such as a pressure of 75 psi or greater. As shown in FIG. 9, the pressure vessel 122 can be a gas cylinder configured to hold carbon dioxide in liquid form under pressure. Nonetheless, the source of carbon dioxide can be either pure carbon dioxide gas or carbon dioxide that is extracted from the air using a packed tower.

In one embodiment, the water from the water supply 116 is passed through the water softener 118 and transferred to the reaction vessel 102. Then, the sodium hydroxide is transferred to the reaction vessel 102. The water and the sodium hydroxide are then recirculated through the reaction vessel 102 at a high flowrate, while the carbon dioxide is introduced to the solution 108 in the reaction vessel 102. The introduction of the carbon dioxide during recirculation of the solution 108 in the reaction vessel 102 allows dissolution of the carbon dioxide into the solution 108 in the reaction vessel 102 at a higher concentration and a faster rate and generates backpressure in the reaction vessel 102.

The system 100 for generating bicarbonate solution can include at least one detector 124 in fluid communication with at least one of the following: the inflow 104 of the water, the inflow 106 of the sodium hydroxide, the inflow 112 of the carbon dioxide gas, the solution 108 in the reaction vessel 102, or any combination thereof. As shown in FIG. 8, the system 100 can include various detectors 124, 124a-124d in fluid communication with each of the inflow 104 of the water, the inflow 106 of the sodium hydroxide, the inflow 112 of the carbon dioxide gas, and the solution 108 in the reaction vessel 102. Specifically, the system 100 can include a detector 124a in fluid communication with the inflow 104 of the water, a detector 124b in fluid communication with the inflow 106 of the sodium hydroxide, a detector 124c in fluid communication with the inflow 112 of the carbon dioxide gas, and a detector 124d in fluid communication with the solution 108 in the reaction vessel 102. In one embodiment, the detector(s) 124, 124a-124d are in contact with the inflow 104 of the water, the inflow 106 of the sodium hydroxide, the inflow 112 of the carbon dioxide gas, and/or the solution 108 in the reaction vessel 102. In another embodiment, the detectors 124, 124a-124d are adjacent to or in proximity to the inflow 104 of the water, the inflow 106 of the sodium hydroxide, the inflow 112 of the carbon dioxide gas, and/or the solution 108 in the reaction vessel 102.

The at least one detector 124, 124a-124d can be in communication with the controller 114 via a second communication connection 134. The at least one detector 124, 124a-124d can be configured to detect at least one property of at least one of the following: the inflow 104 of the water, the inflow 106 of the sodium hydroxide, the inflow 112 of the carbon dioxide gas, the solution 108 in the reaction vessel 102, or any combination thereof. The at least one detector 124, 124a-124d can also be configured to transmit the at least one property to the controller 114 via the second communication connection 134. In one embodiment, the at least one detector 124, 124a-124d can communicate with the controller 114 by, for example, transmitting data to the controller 114 via the second communication connection 134. The data transmitted to the controller 114 by the detector 124, 124a-124d can be the at least one property detected by the detector 124, 124a-124d. The at least one property detected by the at least one detector 124, 124a-124d can be at least one of the following: a concentration, a pH, a temperature, a pressure, an alkalinity, a conductivity, a flow rate, a mass, a volume, or any combination thereof.

For example, the detector 124 can detect a concentration (e.g., mass of solute/total mass of solution) of sodium hydroxide in the inflow 106 of the sodium hydroxide and/or the solution 108 in the reaction vessel 102. The detector 124 can detect a flow rate of the inflow 104 of the water and a flow rate of the inflow 106 of the sodium hydroxide. The detector 124 can detect a pH of the solution 108 in the reaction vessel 102 before exposure to a sparge of carbon dioxide gas and after exposure to a sparge of carbon dioxide gas. The detector 124 can detect an alkalinity (e.g., mg/L as CaCO₃ or milligrams per liter as calcium carbonate) of the solution 108 in the reaction vessel 102 before exposure to a sparge of carbon dioxide gas and after exposure to a sparge of carbon dioxide gas. The detector 124 can detect a conductivity (e.g., mS/cm or millisiemens per centimeter) of the solution 108 in the reaction vessel 102 before exposure to a sparge of carbon dioxide gas and after exposure to a sparge of carbon dioxide gas. The detector 124 can detect a conductivity (e.g., mS/cm or millisiemens per centimeter) of the inflow 104 of the water before mixing with the inflow 106 of the sodium hydroxide and after mixing with the inflow 106 of the sodium hydroxide solution. The detector 124 can detect a conductivity (e.g., mS/cm or millisiemens per centimeter) of the inflow 104 of the water before flowing the water through the water softener 118 and after flowing the water through the water softener 118. The detector 124 can detect a flow rate of at least one of the following: the inflow 104 of the water, the inflow 106 of the sodium hydroxide, the inflow 112 of the carbon dioxide gas, or any combination thereof. The detector 124 can detect a mass or volume of the solution 108 in the reaction vessel 102. The detector 124 can transmit any of the foregoing data and/or properties to the controller 114. The controller 114 can then receive, store, process, and/or output any of the foregoing data and/or properties.

In one embodiment, detector 124a can be a flowmeter, detector 124b can be a conductivity sensor, detector 124c can be pH sensor and/or a temperature sensor, detector 124d can be a level sensor, and detector 124e (shown in FIG. 2) can be a scale. The reaction vessel 102 can also include a detector 124 as a pressure sensor (not shown) that measures a pressure within the reaction vessel 102. The flowmeter 124a can measure a flowrate of the inflow 104 of the water from the water supply 116. The conductivity sensor 124b can detect a conductivity of the solution 108. The pH sensor 124c can detect a pH of the solution 108. The level sensor 124d can detect a level or height of the solution 108 in the reaction vessel 102. The scale 124e (shown in FIG. 9) can detect a mass of the solution 108 in the reaction vessel.

In one embodiment, the at least one property (such as a concentration, a pH, a temperature, a pressure, an alkalinity, a conductivity, a flow rate, a mass, a volume, or any combination thereof) detected by the at least one detector 124, 124a-124d can be transmitted to the controller 114, and the controller 114 can receive and process the at least one property and can control the flow regulating component 130, 130a, 130b based on the at least one property. For example, the detector 124 can detect the at least one property (such as a concentration, a pH, a temperature, a pressure, an alkalinity, a conductivity, a flow rate, a mass, a volume, or any combination thereof) and transmit the at least one property to the controller 114, and the controller 114 can receive and process the at least one property and can control the flow regulating component 130, 130a, 130b by increasing or decreasing a flow rate through the flow regulating component 130, 130a, 130b and/or permitting or stopping flow through the flow regulating component 130, 130a, 130b. In one embodiment, the flow meter 124a can detect a flowrate of the inflow 104 of the water from the water supply 116 and transmit the flowrate to the controller 114, and the controller 114 can receive and process the flowrate and can control the pump 130b to introduce a desired amount of sodium hydroxide so as to dilute the sodium hydroxide content in solution 108 to a target value, such as a value of from approximately 50% to 1% by mass.

Referring to FIGS. 8-10, the system 100 for generating bicarbonate solution can include a gas inlet 126 in fluid communication with the reaction vessel 102. The gas inlet 126 can be configured to introduce a gaseous pressure to the solution 108 in the reaction vessel and/or a headspace 128 of the reaction vessel 102. In one embodiment as shown in FIG. 10, the gas inlet 126 can be the same line or pipe that produces the inflow 112 of carbon dioxide gas into the solution 108 in the reaction vessel 102. The gas inlet 126 can be configured to introduce a gaseous pressure to a headspace 128 of the reaction vessel 102 even if it is done indirectly. For example, if the gas inlet 126 is the same line or pipe that produces the inflow 112 of carbon dioxide gas into the solution 108 in the reaction vessel, the gas inlet can indirectly introduce a gaseous pressure to a headspace 128 of the reaction vessel 102 because the inflow 112 of the carbon dioxide gas that is not consumed by the reaction with sodium hydroxide rises to the headspace 128 of the reaction vessel 102. In another embodiment, the gas inlet 126 can be a different line or pipe than the line or pipe that produces the inflow 112 of carbon dioxide gas into the solution 108 in the reaction vessel 102. The reaction vessel 102 of the system 100 for generating bicarbonate solution can operate under any backpressure needed, in which the backpressure is applied to the reaction vessel 102 (with or without a headspace 128). For example, the reaction vessel 102 of the system 100 for generating bicarbonate solution can operate under any backpressure needed to keep the carbon dioxide gas dissolved in the solution 108 in the reaction vessel 102. The carbon dioxide gas dissolved in the solution 108 in the reaction vessel 102 can exist as carbonic acid (H₂CO₃), carbonate (CO₃²⁻), and/or bicarbonate (HCO₃⁻). However, backpressure is not necessary if the minimum solubility of carbonic acid (H₂CO₃), carbonate (CO₃²⁻), and/or bicarbonate (HCO₃⁻) is not exceeded. Nonetheless, higher backpressure will encourage more of the carbon dioxide gas to dissolve in the solution 108 in the reaction vessel 102 in the form of carbonic acid (H₂CO₃), carbonate (CO₃²⁻), and/or bicarbonate (HCO₃⁻).

In one embodiment as shown in FIG. 9, the system 100 for generating bicarbonate solution can be a self-contained unit or module. That is, each element of the system 100 for generating bicarbonate solution can be present on an independent base, platform, area, or footprint. In this way, the self-contained system 100 can easily be installed and implemented by a user of the system 100 with minimal installation requirements. In another embodiment, the system 100 for generating bicarbonate solution can be a nearly complete self-contained unit or module. For example, the system 100 may include every element except for the consumable elements, such as the water supply 116, a source of power or electricity, the sodium hydroxide, and/or the carbon dioxide. All that may be required by the user is installation of a water supply 116 to the system 100, installation of a source of power or electricity to the system 100, and/or introduction of the sodium hydroxide and the carbon dioxide to the system 100. In this way, the system 100 can still be easily installed and implemented by the user.

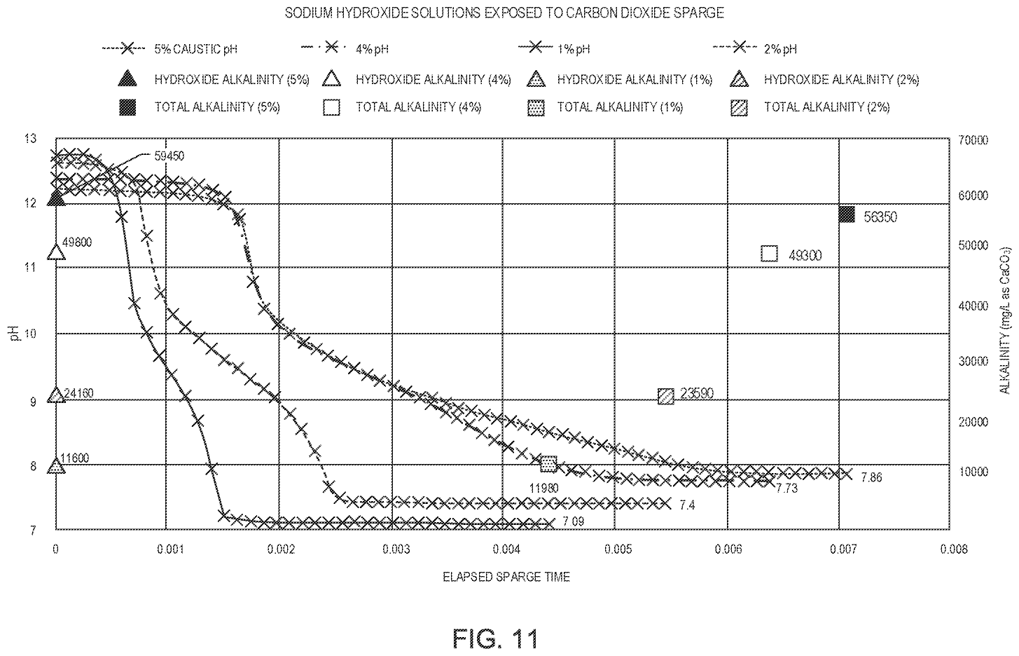

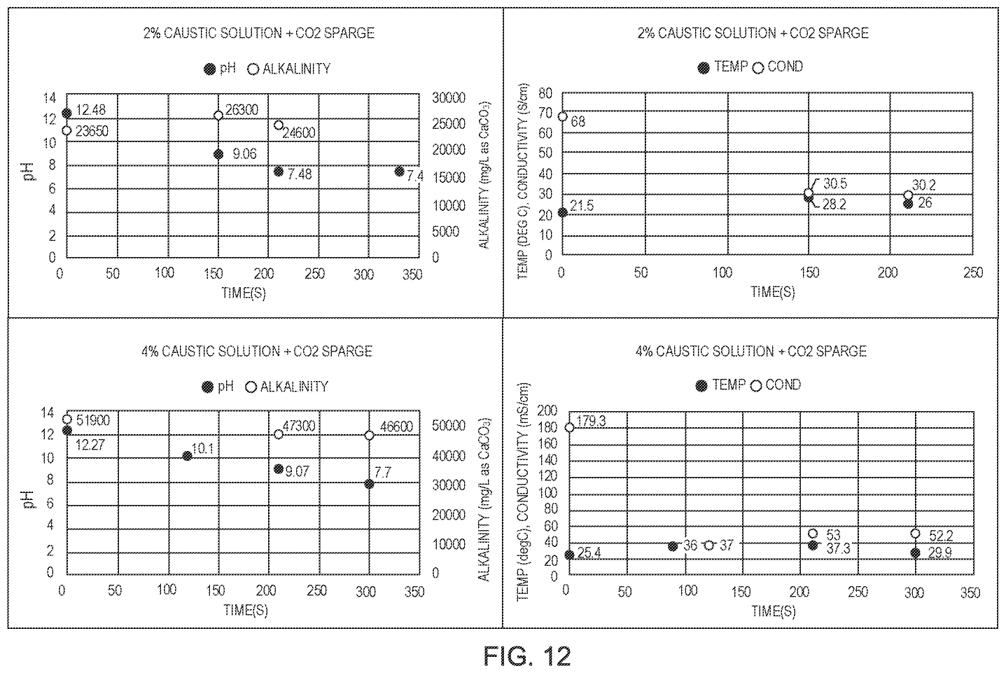

Referring to FIG. 11, there is shown a view of a graph displaying a relationship between elapsed sparge time and pH, and before sparge and after sparge alkalinity values, of various concentrations of sodium hydroxide solutions exposed to a carbon dioxide sparge, according to some non-limiting embodiments or aspects of the present disclosure. Referring to FIG. 12, there is shown a view of multiple graphs displaying a relationship between elapsed sparge time and pH, and before sparge and after sparge alkalinity and conductivity values, of two concentrations of sodium hydroxide solutions exposed to a carbon dioxide sparge, according to some non-limiting embodiments or aspects of the present disclosure.

Referring to FIG. 11, there is shown a graph of multiple sodium hydroxide solutions exposed to a carbon dioxide sparge. As shown in FIG. 11, four concentrations of sodium hydroxide solutions (referred to as “caustic” in FIG. 11) are shown as follows: 5% by mass of sodium hydroxide, 4% by mass of sodium hydroxide, 2% by mass of sodium hydroxide, and 1% by mass of sodium hydroxide. Each of the sodium hydroxide solutions was exposed to a carbon dioxide gas sparge over a period of time (minutes). Each sodium hydroxide solution had a starting pH of between 12 and 13 before the sparge, while each solution had a pH of less than 8 after the carbon dioxide gas sparge. Furthermore, each sodium hydroxide solution had a relatively stable alkalinity value before and after the carbon dioxide gas sparge. Depending on the water quality of the inflow 104 of the water from the water supply 116, the sodium hydroxide concentration in the solution 108 in the reaction vessel can be adjusted, before introducing the carbon dioxide gas, in order to generate a desired bicarbonate (HCO₃⁻) alkalinity concentration. Thus, the graph shown in FIG. 11 illustrates the efficacy of the system 100 and method for converting hydroxide alkalinity (OH⁻) to bicarbonate (HCO₃⁻) alkalinity by sparging various concentrations of sodium hydroxide with carbon dioxide gas.

Referring to FIG. 12, there is shown a graph of two sodium hydroxide solutions exposed to a carbon dioxide sparge. As shown in FIG. 12, two concentrations of sodium hydroxide solutions (referred to as “caustic” in FIG. 12) are shown as follows: 2% by mass of sodium hydroxide and 4% by mass of sodium hydroxide. Each of the sodium hydroxide solutions was exposed to a carbon dioxide gas sparge over a period of time (seconds). Each sodium hydroxide solution had a starting pH of between 12 and 13 before the sparge, while each solution had a pH of less than 8 after the carbon dioxide gas sparge. Furthermore, each sodium hydroxide solution had a relatively stable alkalinity value before and after the carbon dioxide gas sparge. Finally, each sodium hydroxide solution had a significant decrease in conductivity from before the carbon dioxide sparge to after the carbon dioxide sparge, and each sodium hydroxide solution had an increase in temperature from before the carbon dioxide sparge to after the carbon dioxide sparge showing a release in heat. FIG. 12 shows the basis for utilizing monitoring equipment (i.e., a conductivity sensor, a pH sensor, and a temperature sensor), such as detector(s) 124, within system 100, to determine when the reaction of converting sodium hydroxide and carbon dioxide gas to bicarbonate solution is complete based on starting sodium hydroxide concentrations of 2% and 4%. Thus, the graphs shown in FIG. 12 also illustrate the efficacy of the system 100 and method for converting hydroxide alkalinity (OH⁻) to bicarbonate (HCO₃⁻) alkalinity by sparging various concentrations of sodium hydroxide with carbon dioxide gas.

The system 100 for generating bicarbonate solution via in-situ bicarbonate (HCO₃⁻) generation by mixing NaOH with CO₂ can be utilized in lieu of the conventional dissolution approach using NaHCO₃ dry powder. The use of bicarbonate (HCO₃⁻) for resin regeneration eases waste regenerant solution 34 sewer disposal as wastewater nitrification processes may benefit from the presence of alkalinity if the waste regenerant solution 34 is discharged to a municipal wastewater treatment plant.

As stated above, one advantage of using bicarbonate (HCO₃⁻), for resin regeneration and as the counter anion 20 of the ion exchange resin 16 in the disclosed ion exchange system 10 for treating water, is the addition of alkalinity to the treated effluent 26. Addition of alkalinity to the treated effluent 26 makes the treated effluent 26 more suitable for downstream softening in, for example, the softening reactor 44. Referring to FIG. 5, there is a shown a diagram that summarizes the relationship between the processes of ion exchange, bicarbonate regeneration, and softening utilized in the ion exchange system 10 for treating water of the present disclosure. As illustrated in FIG. 5, the net outcome is the removal of DOC, nutrients (e.g., nitrate and phosphate), other anionic constituents (e.g., nitrite, bromide, chloride, sulfate, etc.), alkalinity, calcium, and potentially magnesium from the source water 14. Another net outcome, as illustrated in FIG. 5, is continuous regeneration of the ion exchange resin 16.

In another embodiment, the bicarbonate solution as the regenerant solution 30 may be obtained via other means, other than using the system 100 for generating bicarbonate solution.

The ion exchange system 10 for treating water can include any components and/or equipment necessary to establish connection between the elements thereof. For example, the ion exchange system 10 for treating water can include piping, process equipment, instrumentation, control devices, etc. that establish connection between the elements of the system 10. Similarly, the system 100 for generating bicarbonate solution can include any components and/or equipment necessary to establish connection between the elements thereof. For example, the system 100 for generating bicarbonate solution can include piping, process equipment, instrumentation, control devices, etc. that establish connection between the elements of the system 100.

The present disclosure also relates to a method for treating water. The method for treating water can include flowing water and ion exchange resin through and out of a reactor. The ion exchange resin includes a positively charged resin bead and at least one counter anion bonded to the resin bead. The water includes at least one contaminant anion therein. The flow of the water and the ion exchange resin is a continuous, semi-plug flow. The ion exchange resin is suspended in the water and exchanges one or more of the at least one counter anion with one or more of at least one contaminant anion dissolved in the water during the flow through and out of the plug flow reactor. The method for treating water can include separating at least a portion of the water from the ion exchange resin. The separated portion of the water includes a treated effluent, and the treated effluent includes one or more of the at least one counter anion therein. The method for treating water can include regenerating the ion exchange resin by contacting the ion exchange resin with a regenerant solution. The regenerant solution includes at least one regenerant anion therein. The ion exchange resin exchanges one or more of the at least one contaminant anion with one or more of the at least one regenerant anion in the regenerant solution. The method for treating water can include separating a waste regenerant solution from the ion exchange resin. The waste regenerant solution includes the at least one contaminant anion therein. The method for treating water can utilize any of the above-described elements of the ion exchange system 10 for treating water.

The method for treating water can include rinsing the ion exchange resin with a rinse water, suspending the ion exchange resin in the rinse water, and returning the ion exchange resin to the reactor.

The method for treating water can include flowing the treated effluent, calcium hydroxide, and a seeding material upward through a softening reactor. The at least one counter anion dissolved in the treated effluent and the calcium hydroxide react and form a precipitated solid on the surface of the seeding material in the treated effluent. The precipitated solid settles in the treated effluent to a bottom of the softening reactor.

The method for treating water can include separating at least a portion of the treated effluent from the precipitated solid. The separated portion of the treated effluent can be a treated and softened effluent. The method for treating water can include removing the precipitated solids from the softening reactor. The method for treating water can include using at least a portion of the treated and softened effluent as the rinse water by rinsing the ion exchange with the treated and softened effluent.

Each of the at least one counter anion and the at least one regenerant anion can be bicarbonate (HCO₃⁻) and the regenerant solution can be a bicarbonate solution. The method for treating water can utilize a method for generating bicarbonate solution, as the regenerant solution. The method for generating bicarbonate solution can include flowing water (H₂O) into a vessel. The method for generating bicarbonate solution can include introducing sodium hydroxide (NaOH) into the vessel. The water and the sodium hydroxide combine to form a solution. The method for generating bicarbonate solution can include sparging a carbon dioxide (CO₂) gas in the solution. The sodium hydroxide and the carbon dioxide react to form at least bicarbonate (HCO₃⁻) in the solution. The method for generating bicarbonate solution can utilize any of the above-described elements of the system 100 for generating bicarbonate solution.

The method for generating bicarbonate solution can include controlling the flow of the water, the flow of sodium hydroxide, and the flow of the carbon dioxide gas with a controller. The method for generating bicarbonate solution can include flowing the water through a water softener before flowing the water into the vessel. The method for generating bicarbonate solution can include detecting at least one property of at least one of the following: the water flowing into the vessel, the sodium hydroxide flowing into the vessel, the carbon dioxide gas sparging in the solution, the solution in the vessel, or any combination thereof. The method for generating bicarbonate solution can include transmitting the at least one property to the controller. The at least one property is at least one of the following: a concentration, a pH, a temperature, a pressure, an alkalinity, a conductivity, a flow rate, a mass, a volume, or any combination thereof. The method for generating bicarbonate solution can include introducing a gaseous pressure to at least one of the following: the solution in the vessel, the headspace of the vessel or a combination thereof. The method for generating bicarbonate solution can include transferring the solution from the vessel after detecting the at least one property of at least one of the following: the water flowing into the vessel, the sodium hydroxide flowing into the vessel, the carbon dioxide gas sparging in the solution, the solution in the vessel, the gas in the headspace of the vessel, or any combination thereof.

The method for treating water can include flowing the water and the ion exchange resin through the reactor for approximately 10 to 30 minutes. The method for treating water can include flowing the treated and softened effluent from the softening reactor through at least one advanced treatment system. The at least one advanced treatment system includes at least one of the following: microfiltration (MF), ultrafiltration (UF), granular media filtration (GMF), ozone (O₃) treatment, biological activated carbon (BAC) treatment, biological active filtration (BAF), granular activated carbon (GAC) treatment, ultraviolet light (UV) treatment, ultraviolet light-advanced oxidation process (UV-AOP) treatment, chlorine contact treatment, or any combination thereof.

The method for treating water can include storing the ion exchange resin in a resin holder before returning the ion exchange resin to the reactor. Returning the ion exchange resin to the reactor can include metering the ion exchange resin to the reactor or controlling a rate of return of the ion exchange resin to the reactor.

While exemplary designs have been described above in the detailed description, those of ordinary skill in the art will understand that the exemplary designs of the present disclosure can be further modified within the spirit and scope of this disclosure. Therefore, the above-described exemplary designs should not be considered to limit the scope of the appended claims.

1. An ion exchange system for treating water, the system comprising:
a semi-plug flow reactor comprising an inflow of water and ion exchange resin, the ion exchange resin comprising a positively charged resin bead and at least one counter anion bonded to the resin bead, and the water comprising at least one contaminant anion therein,
wherein the semi-plug flow reactor is configured to allow a continuous, semi-plug flow of the water and the ion exchange resin through and out of the semi-plug flow reactor, and
wherein the ion exchange resin is suspended in the water and exchanges one or more of the at least one counter anion with one or more of the at least one contaminant anion in the water during the flow through and out of the semi-plug flow reactor;
a resin separator in fluid communication with the semi-plug flow reactor, the resin separator comprising an inflow of the water and the ion exchange resin from the semi-plug flow reactor,
wherein the resin separator is configured to separate at least a portion of the water from the ion exchange resin, the separated portion of the water comprising a treated effluent, and the treated effluent comprising one or more of the at least one counter anion therein;
a resin regeneration vessel in fluid communication with the resin separator, the resin regeneration vessel comprising an inflow of the ion exchange resin from the resin separator and an inflow of a regenerant solution, the regenerant solution comprising at least one regenerant anion therein,
wherein the ion exchange resin exchanges one or more of the at least one contaminant anion with one or more of the at least one regenerant anion in the regenerant solution, and
wherein the resin regeneration vessel is configured to separate a waste regenerant solution from the ion exchange resin, the waste regenerant solution comprising one or more of the at least one contaminant anion therein.

2. The ion exchange system for treating water of claim 1, further comprising:
a resin return line in fluid communication with the resin regeneration vessel,
wherein the resin return line is configured to return the ion exchange resin to the semi-plug flow reactor.

3. The ion exchange system for treating water of claim 1, further comprising:
a resin holder in fluid communication with the resin regeneration vessel, the resin holder comprising an inflow of the ion exchange resin from the resin regeneration vessel and an inflow of rinse water,
wherein the resin holder is configured to suspend the ion exchange resin in the rinse water.

4. The ion exchange system for treating water of claim 3, further comprising:
a resin return line in fluid communication with the resin holder,
wherein the resin return line is configured to return the ion exchange resin to the semi-plug flow reactor.

5. The ion exchange system for treating water of claim 1, further comprising:
a softening reactor in fluid communication with the resin separator, the softening reactor comprising an inflow of the treated effluent from the resin separator, an inflow of calcium hydroxide (Ca(OH)₂), and an inflow of a seeding material,
wherein the softening reactor is configured to generate an upward flow of the treated effluent, the calcium hydroxide, and the seeding material therein,
wherein the at least one counter anion in the treated effluent and the calcium hydroxide react and form a precipitated solid on a surface of the seeding material in the treated effluent, and
wherein the precipitated solid settles in the treated effluent to a bottom of the softening reactor.

6. The ion exchange system for treating water of claim 5, wherein the softening reactor is an upflow fluidized reactor

7. The ion exchange system for treating water of claim 5, wherein the softening reactor is configured to:
separate at least a portion of the treated effluent from the precipitated solid, the separated portion of the treated effluent comprising a treated and softened effluent, and
remove the precipitated solid settled therein.

8. The ion exchange system for treating water of claim 7, wherein the softening reactor is in fluid communication with the resin holder, and wherein the inflow of the rinse water comprises the treated and softened effluent separated from the softening reactor.

9. The ion exchange system for treating water of claim 7, further comprising:
a hopper in fluid communication with the softening reactor, the hopper comprising an inflow of the precipitated solid from the softening reactor, wherein the hopper is configured to hold, dry, and dispense the precipitated solid.

10. The ion exchange system for treating water of claim 1, wherein each of the at least one counter anion and the at least one regenerant anion comprises bicarbonate (HCO₃⁻) and the regenerant solution comprises a bicarbonate solution.

11. The ion exchange system for treating water of claim 10, further comprising:
a system for generating the bicarbonate solution, as the regenerant solution, in fluid communication with the resin regeneration vessel and in-line with the inflow of the regenerant solution, the system for generating bicarbonate solution comprising:
a reaction vessel comprising an inflow of water (H₂O) and sodium hydroxide (NaOH), wherein the water and the sodium hydroxide combine to form a solution in the reaction vessel;
a gas sparger in fluid communication with the reaction vessel, the gas sparger comprising an inflow of gas comprising carbon dioxide (CO₂) into the solution in the reaction vessel; and
wherein the sodium hydroxide and the carbon dioxide react to form at least bicarbonate (HCO₃⁻) in the solution.

12. The ion exchange system for treating water of claim 11, wherein the system for generating bicarbonate solution further comprises:
a controller in communication with the inflow of the water, the inflow of the sodium hydroxide, and the inflow of the gas comprising carbon dioxide,
wherein the controller is configured to control a flow of the inflow of the water, the inflow of the sodium hydroxide, and the inflow of the gas comprising carbon dioxide.

13. The ion exchange system for treating water of claim 1, wherein the at least one contaminant anion comprises at least one of the following: dissolved organic carbon (DOC), nitrate (NO₃⁻), nitrite (NO₂⁻), sulfate (SO₄²⁻), bicarbonate (HCO₃⁻), phosphate (PO₄³⁻), chloride (Cl⁻), bromide (Br⁻), anionic perfluoroalkyl and polyfluoroalkyl substances (PFAS), or any combination thereof.

14. The ion exchange system for treating water of claim 1, wherein the flow of the water and the ion exchange resin through the semi-plug flow reactor comprises a flow time of approximately 10 to 30 minutes.

15. The ion exchange system for treating water of claim 1, wherein the resin separator is a plate settler.

16. The ion exchange system for treating water of claim 5, further comprising:
a calcium hydroxide holding vessel in fluid communication with the softening reactor and in-line with the inflow of the calcium hydroxide, wherein the calcium hydroxide is in a liquid solution in the holding vessel.

17. The ion exchange system for treating water of claim 7, further comprising:
at least one advanced treatment system for treating water in fluid communication with the softening reactor, the at least one advanced treatment system comprising an inflow of the treated and softened effluent separated from the softening reactor.

18. The ion exchange system for treating water of claim 17, wherein the at least one advanced treatment system comprises at least one of the following: microfiltration (MF), ultrafiltration (UF), granular media filtration (GMF), ozone (O₃) treatment, biological activated carbon (BAC) treatment, biological active filtration (BAF), granular activated carbon (GAC) treatment, ultraviolet light (UV) treatment, ultraviolet light-advanced oxidation process (UV-AOP) treatment, chlorine contact treatment, or any combination thereof.

19. A method for treating water, comprising:
flowing water and ion exchange resin through and out of a reactor, the ion exchange resin comprising a positively charged resin bead and at least one counter anion bonded to the resin bead, and the water comprising at least one contaminant anion therein,
wherein the flow of the water and the ion exchange resin is a continuous, semi-plug flow, and
wherein the ion exchange resin is suspended in the water and exchanges one or more of the at least one counter anion with one or more of at least one contaminant anion in the water during the flow through and out of the plug flow reactor;
separating at least a portion of the water from the ion exchange resin, the separated portion of the water comprising a treated effluent, and the treated effluent comprising one or more of the at least one counter anion therein;
regenerating the ion exchange resin by contacting the ion exchange resin with a regenerant solution, the regenerant solution comprising at least one regenerant anion therein,
wherein the ion exchange resin exchanges one or more of the at least one contaminant anion with one or more of the at least one regenerant anion in the regenerant solution;
separating a waste regenerant solution from the ion exchange resin, the waste regenerant solution comprising the at least one contaminant anion therein.

20. The method for treating water of claim 19, further comprising:
rinsing the ion exchange resin with a rinse water;
suspending the ion exchange resin in the rinse water; and
returning the ion exchange resin to the reactor.

21. The method for treating water of claim 19, further comprising:
flowing the treated effluent, calcium hydroxide, and a seeding material upward through a softening reactor,
wherein the at least one counter anion in the treated effluent and the calcium hydroxide react and form a precipitated solid on the surface of the seeding material in the treated effluent, and
wherein the precipitated solid settles in the treated effluent to a bottom of the softening reactor.

22. The method for treating water of claim 21, further comprising:
separating at least a portion of the treated effluent from the precipitated solid, the separated portion of the treated effluent comprising a treated and softened effluent, and
removing the precipitated solid from the softening reactor.

23. The method for treating water of claim 22, further comprising:
using at least a portion of the treated and softened effluent as the rinse water by rinsing the ion exchange with the treated and softened effluent.

24. The method for treating water of claim 19, wherein each of the at least one counter anion and the at least one regenerant anion comprises bicarbonate (HCO₃⁻) and the regenerant solution comprises a bicarbonate solution.

25. The method for treating water of claim 24, further comprising:
a method for generating bicarbonate solution, as the regenerant solution, the method for generating bicarbonate solution comprising:
flowing water (H₂O) into a vessel;
introducing sodium hydroxide (NaOH) into the vessel, wherein the water and the sodium hydroxide combine to form a solution; and
sparging a gas comprising carbon dioxide (CO₂) in the solution,
wherein the sodium hydroxide and the carbon dioxide react to form at least bicarbonate (HCO₃⁻) in the solution.

26. The method for treating water of claim 25, wherein the method for generating bicarbonate solution further comprises:
controlling a flow of the water, the sodium hydroxide, and the gas comprising carbon dioxide with a controller.

27. The method for treating water of claim 19, further comprising:
flowing the water and the ion exchange resin through the reactor for approximately 10 to 30 minutes.

28. The method for treating water of claim 22, further comprising:
flowing the treated and softened effluent from the softening reactor through at least one advanced treatment system.

29. The method for treating water of claim 28, wherein the at least one advanced treatment system comprises at least one of the following: microfiltration (MF), ultrafiltration (UF), granular media filtration (GMF), ozone (O₃) treatment, biological activated carbon (BAC) treatment, biological active filtration (BAF), granular activated carbon (GAC) treatment, ultraviolet light (UV) treatment, ultraviolet light-advanced oxidation process (UV-AOP) treatment, chlorine contact treatment, or any combination thereof.
